(19) United States
(12) Patent Application Publication
(10) Pub. No.: US 2017/0352091 A1
(43) Pub. Date: Dec. 7, 2017

(54) METHODS FOR GENERATING A 3D VIRTUAL BODY MODEL OF A PERSON COMBINED WITH A 3D GARMENT IMAGE, AND RELATED DEVICES, SYSTEMS AND COMPUTER PROGRAM PRODUCTS

(71) Applicant: METAIL LIMITED, London (GB)

(72) Inventors: Yu CHEN, London (GB); Nic MARKS, London (GB); Diana NIKOLOVA, London (GB); Luke SMITH, London (GB); Ray MILLER, London (GB); Joe TOWNSEND, London (GB); Nick DAY, London (GB); Rob MURPHY, London (GB); Jim DOWNING, London (GB); Edward CLAY, London (GB); Michael MAHER, London (GB); Tom ADEYOOLA, London (GB)

(21) Appl. No.: 15/536,894

(22) PCT Filed: Dec. 16, 2015
(86) PCT No.: PCT/GB2015/054042

§ 371 Date: Jun. 16, 2017

(30) Foreign Application Priority Data
Dec. 16, 2014 (GB) 1422401.8
Feb. 19, 2015 (GB) 1502806.1
Aug. 14, 2015 (GB) 1514450.4

(51) Int. Cl. G06Q 30/06; G06T 19/20; G06F 3/0482; G06F 3/0484

(52) U.S. Cl. CPC G06Q 30/0643; G06F 3/04845; G06T 19/20; G06F 3/0482; G06F 3/04842; G06T 2210/16

(57) ABSTRACT

A method for generating a 3D virtual body model of a person combined with a 3D garment image, and displaying the 3D virtual body model of the person combined with the 3D garment image on a screen of a computing device, the computing device including a sensor system, the method including the steps of; (a) generating the 3D virtual body model; (b) generating the 3D garment image for superimposing on the 3D virtual body model; (c ) superimposing the 3D garment image on the 3D virtual body model; (d) showing on the screen the 3D garment image superimposed on the 3D virtual body model; (e) detecting a position change using the sensor system, and (f) showing on the screen the 3D garment image superimposed on the 3D virtual body model modified in response to the position change detected using the sensor system.

### BACKGROUND OF THE INVENTION

### 1. Field of the Invention

The field of the invention relates to methods for generating a 3D virtual body model of a person combined with a 3D garment image, as well as to related devices, systems and computer program products.

### 2. Technical Background

When selling clothes, clothing shops or stores tend to display a sample of the clothes on mannequins so that customers may view the sample of the clothes in a way that mimics how the clothes might look on the customer. Such a viewing is inherently a 3D experience, because a viewer can move through the shop or store, or move around the mannequin, while looking at the clothed mannequin, so as to view the garment on the mannequin from various perspectives. Displaying clothing from different perspectives is a highly desirable goal: fashion houses use models who walk up and down a catwalk to display the items of clothing. When a model walks up and down a catwalk, a viewer is automatically presented with a large number of perspectives of the items of clothing, in 3D. However, using fashion models to display items of clothing at a fashion show is a time consuming and an expensive undertaking.

It is known to show items of clothing on a 3D body model on a computer screen. But it is desirable to provide a technical solution to the problem that showing items of clothing on a 3D body model on a computer screen does not replicate in a simple and low cost way the technical experience of viewing items of clothing on a mannequin while moving through a clothes shop or store, or while moving around the mannequin, or while viewing a model walking up and down a catwalk.

There are some aspects of shopping for clothes in which the available options are far from ideal. For example, if a user wants to decide what to buy, she may have to try on various items of clothing. When wearing the last item of clothing and viewing themselves in a mirror in a fitting room, the user then has to decide, from memory, how that item of clothing compares to other items of clothing she has already tried on. And because she can only try on one outfit at a time, it is physically impossible for the user to compare herself in different outfits at the same time. A user may also like to compare herself in an outfit near to another user (possibly a rival) in the same outfit or in a different outfit. But another user may be unwilling to participate in such a comparison, or it may be impractical for the other user to participate in such a comparison. It is desirable to provide an improved way of comparing outfits, and of comparing different users in different outfits.

It is known to show items of clothing on a 3D body model on a computer screen, but because of the relatively detailed view required, and because of the many options which may be necessary to view a desired item of clothing on a suitable 3D body model, and because of typically the requirement to register with a service which offers viewing of garments on 3D body models, mobile computing devices have hitherto been relatively unsuitable for such a task. It is desirable to provide a method of viewing a selected item of clothing on a 3D body model on a mobile computing device which overcomes at least some of these problems.

### 3. Discussion of Related Art

WO2012110828A1, GB2488237A and GB2488237B, which are incorporated by reference, disclose a method for generating and sharing a 3D virtual body model of a person combined with an image of a garment, in which:

(a) the 3D virtual body model is generated from user data;

(b) a 3D garment image is generated by analysing and processing multiple 2D photographs of the garment; and

(c) the 3D garment image is shown super-imposed over the 3D virtual body model. A system adapted or operable to perform the method is also disclosed.

EP0936593B1 discloses a system which provides a full image field formed by two fixed sectors, a back sector and a front sector, separated by a mobile part sector formed by one or more elements corresponding to the rider clothing and various riding accessories. The mobile part sector, being in the middle of the image, gives a dynamic effect to the whole stamping thus creating a macroscopic, dynamical, three-dimensional sight perception. To obtain the correct sight view of the mark stamping a scanner is used to receive three-dimensional data making part of the physical model: motorcycle and rider. Subsequently the three-dimensional data at disposal as well as the mark stamping data are entered in a computer with a special software, then the stated data are processed to obtain a complete image of the deforming stamping as the said image gets the characteristics of the data base or surface to be covered. The image thus obtained is applied in the curved surface without its sight perception getting altered.

### SUMMARY OF THE INVENTION

According to a first aspect of the invention, there is provided a method for generating a 3D virtual body model of a person combined with a 3D garment image, and displaying the 3D virtual body model of the person combined with the 3D garment image on a screen of a computing device, the computing device including a sensor system, the method including the steps of:

(a) generating the 3D virtual body model;

(b) generating the 3D garment image for superimposing on the 3D virtual body model;

(c ) superimposing the 3D garment image on the 3D virtual body model;

(d) showing on the screen the 3D garment image superimposed on the 3D virtual body model;

(e) detecting a position change using the sensor system, and

(f) showing on the screen the 3D garment image superimposed on the 3D virtual body model, modified in response to the position change detected using the sensor system.

An advantage is that a user is provided with a different view of a 3D garment superimposed on a 3D virtual body model, in response to modifying their position, which technically is similar to a user obtaining a different view of a garment on a mannequin, as the user moves around the mannequin. The user may alternatively tilt the computing device, and be provided with a technically similar effect.

The method may be one wherein the modified 3D garment image superimposed on the 3D virtual body model shown on the screen is modified in perspective.

The method may be one wherein 3D virtual body model image modification is provided using a sequence of pre-rendered images. An advantage is that the required computing time between position change and providing the modified image is reduced.

The method may be one wherein the 3D virtual body model is shown to rotate by use of a progressive sequence of images depicting the 3D virtual body model at different angles.

The method may be one wherein the position change is a tilting of the screen surface normal vector. An advantage is that a user does not have to move; instead they can simply tilt their computing device.

The method may be one wherein the sensor system includes an accelerometer. The method may be one wherein the sensor system includes a gyroscope. The method may be one wherein the sensor system includes a magnetometer.

The method may be one wherein the a user is given the feeling of being able to move around the sides of the 3D virtual body model by tilting the computing device.

The method may be one wherein the sensor system includes a camera of the computing device. A camera may be a visible light camera. A camera may be an infra red camera.

The method may be one wherein the sensor system includes a pair of stereoscopic cameras of the computing device. An advantage is improved accuracy of position change detection.

The method may be one wherein the position change is a movement of a head of a user. An advantage is that technically the user moves in a way that is the same or similar to how they would move to view a real object from a different angle.

The method may be one wherein the position change is detected using a head tracker module.

The method may be one wherein the user is given the feeling of being able to move around the sides of the 3D virtual body model by moving their head around the computing device.

The method may be one wherein the images and other objects on the screen move automatically in response to user head movement.

The method may be one wherein the computing device is a mobile computing device.

The method may be one wherein the mobile computing device is a mobile phone, or a tablet computer, or a head mounted display. A mobile phone may be a smartphone.

The method may be one wherein the mobile computing device asks a user to rotate the mobile computing device, in order to continue. An advantage is that the user is encouraged to view the content in the format (portrait or landscape) in which it was intended to be viewed.

The method may be one wherein the computing device is a desktop computer, or a laptop computer, or a smart TV, or a head mounted display. Use of a smart TV may include use of an active (shuttered glasses) 3D display, or of a passive (polarising glasses) 3D display.

The method may be one wherein the 3D virtual body model is generated from user data.

The method may be one wherein the 3D garment image is generated by analysing and processing one or multiple 2D photographs of a garment.

The method may be one wherein the screen shows a scene, in which the scene is set with the midpoint of the 3D virtual body model's feet as the pivot point, so the user is given the impression of moving around the model to see the different angles.

The method may be one wherein a scene consists of at least three images: the 3D body model, a distant background, and a floor.

The method may be one wherein background images are programmatically converted into a 3D geometry.

The method may be one wherein a distant part of the background is placed independently of the floor section, with the distant image placed as a vertical plane, and the floor image oriented such that the top of the floor image is deeper than the bottom of the floor image.

The method may be one wherein the background and floor images are separated, by dividing a background image at a horizon line.

The method may be one wherein a depth value for each background image is set and stored in metadata for a resource of the background image.

The method may be one wherein within the screen, a scene is presented within a frame to keep it separate from other features, and the frame crops the contents so that when zoomed in or rotated significantly, edge portions of the scene are not visible.

The method may be one wherein a stereo vision of the 3D virtual body model is created on a 3D display device, by generating a left-eye/right-eye image pair with 3D virtual body model images rendered in two distinct rotational positions.

The method may be one wherein the 3D display device is an active (shuttered glasses) 3D display, or a passive (polarising glasses) 3D display.

The method may be one wherein the 3D display device is used together with a smart TV.

The method may be one wherein a user interface is provided including a variety of settings to customize sensitivity and scene appearance.

The method may be one wherein the settings include one or more of: iterate through available background images, iterate through available garments for which images are stored, set a maximum viewing angle, set a maximum virtual avatar image rotation to be displayed, set an increment by which the virtual avatar image should rotate, set an image size to be used, zoom in/out on the virtual avatar and background section of a main screen.

The method may be one wherein when a 3D textured geometry of the 3D virtual body model and the 3D garment dressed on the 3D virtual body model are all present, generating a render with a rotated 3D virtual body model is implemented by applying a camera view rotation along the vertical axis during the rendering process.

The method may be one wherein when 2D garment models are used for outfitting, generating a rotated version of 2D garment models involves first approximating the 3D geometry of the 2D garment model based on assumptions, performing a depth calculation and finally a corresponding 2D texture movement is applied to the image in order to emulate a 3D rotation.

The method may be one wherein for a 2D torso-based garment model with a single 2D texture cut-out or silhouette, the 3D geometry model of the garment is approximated by applying the following simplifications: around the upper body, the garment closely follows the geometry of the underlying body shape; around the lower body, the garment approximates to an elliptic cylinder with varying axis lengths, centred at the origin of the body.

The method may be one including the steps of: generating a smooth 3D mesh with faces from a point cloud of vertices given by depth approximations at each pixel, and generating a final normalised depth map of the garment for a required view.

The method may be one wherein the depth map is used to calculate the extent to which a given point on the garment texture needs to move in the image in order to simulate an out-of-plane rotation about the vertical axis.

The method may be one wherein an underlying head and neck base geometry of the user's 3D body shape model is used as an approximate 3D geometry and modeling a 3D rotation of the head sprite/hairstyle from a single 2D texture image using an approach of 2D texture morphing and morph field extrapolation is performed.

According to a second aspect of the invention, there is provided a computing device including a screen, a sensor system and a processor, the computing device configured to generate a 3D virtual body model of a person combined with a 3D garment image, and to display the 3D virtual body model of the person combined with the 3D garment image on the screen, in which the processor:

(a) generates the 3D virtual body model;

(b) generates the 3D garment image for superimposing on the 3D virtual body model;

(c) superimposes the 3D garment image on the 3D virtual body model;

(d) shows on the screen the 3D garment image superimposed on the 3D virtual body model;

(e) detects a position change using the sensor system, and

(f) shows on the screen the 3D garment image superimposed on the 3D virtual body model, modified in response to the position change detected using the sensor system.

The computing device may be further configured to perform a method of any aspect of the first aspect of the invention.

According to a third aspect of the invention, there is provided a system including a server and a computing device in communication with the server, the computing device including a screen, a sensor system and a processor, the server configured to generate a 3D virtual body model of a person combined with a 3D garment image, and to transmit to the computing device an image of the 3D virtual body model of the person combined with the 3D garment image, in which the server:

(a) generates the 3D virtual body model;

(b) generates the 3D garment image for superimposing on the 3D virtual body model;

(c) superimposes the 3D garment image on the 3D virtual body model;

(d) transmits the image of the superimposed the 3D garment image on the 3D virtual body model to the computing device;

and in which the computing device:

(e) shows on the screen the 3D garment image superimposed on the 3D virtual body model;

(f) detects a position change using the sensor system, and

(g) transmits to the server a request for a 3D garment image superimposed on the 3D virtual body model, modified in response to the position change detected using the sensor system;

and in which the server

(h) transmits an image of the superimposed the 3D garment image on the 3D virtual body model to the computing device, modified in response to the position change detected using the sensor system;

and in which the computing device:

(i) shows on the screen the 3D garment image superimposed on the 3D virtual body model, modified in response to the position change detected using the sensor system.

The system may be further configured to perform a method of any aspect according to the first aspect of the invention.

According to a fourth aspect of the invention, there is provided a computer program product executable on a computing device including a processor, the computer program product configured to generate a 3D virtual body model of a person combined with a 3D garment image, and to provide for display the 3D virtual body model of the person combined with the 3D garment image, in which the computer program product is configured to:

(a) generate the 3D virtual body model;

(b) generate the 3D garment image for superimposing on the 3D virtual body model;

(c) superimpose the 3D garment image on the 3D virtual body model;

(d) provide for display on a screen the 3D garment image superimposed on the 3D virtual body model;

(e) receive a detection of a position change using a sensor system, and

(f) provide for display on the screen the 3D garment image superimposed on the 3D virtual body model, modified in response to the position change detected using the sensor system.

The computer program product may be further configured to perform a method of any aspect according to a first aspect of the invention.

According to a fifth aspect of the invention, there is provided a method for generating a plurality of 3D virtual body models, each 3D virtual body model combined with a respective different 3D garment image, and displaying the plurality of 3D virtual body models, each combined with the respective different 3D garment image, in a single scene, on a screen of a computing device, the method including the steps of:

(a) generating the plurality of 3D virtual body models;

(b) generating the respective different 3D garment images for superimposing on the plurality of 3D virtual body models;

(c) superimposing the respective different 3D garment images on the plurality of 3D virtual body models, and

(d) showing on the screen in a single scene the respective different 3D garment images superimposed on the plurality of 3D virtual body models.

Because a scene is provided in which respective different 3D garment images are superimposed on the plurality of 3D virtual body models, an advantage is that such a scene may be assembled relatively quickly and cheaply, which are technical advantages relative to the alternative of having to hire a plurality of models and clothe them in order to provide an equivalent real-life scene. A further advantage is that a user may compare herself in a particular outfit to herself in various other outfits, something which would be physically impossible, because the user cannot physically model more than one outfit at a time.

The method may be one wherein the plurality of 3D virtual body models is of a plurality of respective different people. An advantage is that a user may compare herself in a particular outfit to other users in her social group in various outfits, without having to assemble the real people and actually clothe them in the outfits, something those real people may be unavailable to do, or unwilling to do.

The method may be one wherein the plurality of 3D virtual body models is shown at respective different viewing angles.

The method may be one wherein the plurality of 3D virtual body models is at least three 3D virtual body models. An advantage is that more than two models may be compared at one time.

The method may be one wherein a screen image is generated using a visualisation engine which allows different 3D virtual body models to be modelled along with garments on a range of body shapes.

The method may be one wherein 3D virtual body models in a screen scene are distributed in multiple rows.

The method may be one wherein within each row the 3D virtual body models are evenly spaced.

The method may be one wherein the screen scene shows 3D virtual body models in perspective.

The method may be one wherein garments are allocated to each 3D virtual body model randomly, or pre-determined by user input, or as a result of a search by a user, or created by another user, or determined by an algorithm.

The method may be one wherein the single scene of a set of 3D virtual body models is scrollable on the screen. The method may be one wherein the single scene of a set of 3D virtual body models is horizontally scrollable on the screen.

The method may be one wherein a seamless experience is given by repeating the scene if the user scrolls to the end of the set of 3D virtual body models.

The method may be one wherein the single scene is providable in profile or in landscape aspects.

The method may be one wherein the screen is a touch screen.

The method may be one wherein touching an outfit on the screen provides details of the garments.

The method may be one wherein touching an outfit on the screen provides a related catwalk video.

The method may be one wherein the scene moves in response to a user's finger sliding horizontally over the screen.

The method may be one wherein with this operation, all the body models in the screen move with predefined velocities to generate the effect of a translational camera view displacement in a perspective scene.

The method may be one wherein by applying different sliding speeds to different depth layers in the scene, a perspective dynamic layering effect is provided.

The method may be one wherein a horizontal translation of each 3D virtual body model is inversely proportional to a depth of each 3D virtual body model in the scene.

The method may be one wherein when a user swipes, and their finger lifts off the touchscreen, the all layers gradually halt.

The method may be one wherein the scene switches to the next floor, upstairs or downstairs, in response to a user sliding their finger over the screen, vertically downwards or vertically upwards, respectively.

The method may be one wherein after the scene switches to the next floor, the 3D virtual body models formerly in the background come to the foreground, while the 3D virtual body models formerly in the foreground move to the background.

The method may be one wherein a centroid position of each 3D virtual body model follows an elliptical trajectory during the switching transformation.

The method may be one wherein in each floor, garments and/or outfits of a trend or a brand are displayable.

The method may be one wherein a fog model, with respect to the translucency and the depth of the 3D virtual body models, is applied to model the translucency of different depth layers in a scene.

The method may be one wherein the computing device includes a sensor system, the method including the steps of

(e) detecting a position change using the sensor system, and

(f) showing on the screen the 3D garment images superimposed on the 3D virtual body models, modified in response to the position change detected using the sensor system.

The method may be one wherein the modification is a modification in perspective.

The method may be one wherein the position change is a tilting of the screen surface normal vector.

The method may be one wherein the sensor system includes an accelerometer.

The method may be one wherein the sensor system includes a gyroscope.

The method may be one wherein the sensor system includes a magnetometer.

The method may be one wherein the sensor system includes a camera of the computing device. A camera may be a visible light camera. A camera may be an infra red camera.

The method may be one wherein the sensor system includes a pair of stereoscopic cameras of the computing device.

The method may be one wherein the position change is a movement of a head of a user.

The method may be one wherein the position change is detected using a head tracker module.

The method may be one wherein the images and other objects move automatically in response to user head movement.

The method may be one wherein the computing device is a mobile computing device.

The method may be one wherein the mobile computing device is a mobile phone, or a tablet computer, or a head mounted display.

The method may be one wherein the mobile computing device is a mobile phone and wherein no more than 3.5 3D virtual body models appear on the mobile phone screen.

The method may be one wherein the computing device is a desktop computer, or a laptop computer, or a smart TV, or a head mounted display. Use of a smart TV may include use of an active (shuttered glasses) 3D display, or of a passive (polarising glasses) 3D display.

The method may be one wherein the 3D virtual body models are generated from user data.

The method may be one wherein the 3D garment images are generated by analysing and processing one or multiple 2D photographs of the garments.

The method may be one wherein in the scene, a floor and a background are images that makes it look like the crowd is in a particular location.

The method may be one wherein a background and a floor can be chosen by the user or customized to match some garment collections.

The method may be one wherein a lighting variation on the background is included in the displayed scene.

The method may be one wherein a user can interact with the 3D virtual body models to navigate through the 3D virtual body models.

The method may be one wherein selecting a model allows the user to see details of the outfit on the model.

The method may be one wherein the user can try the outfit on their own 3D virtual body model.

The method may be one wherein selecting an icon next to a 3D virtual body model allows one or more of: sharing with others, liking on social media, saving for later, and rating.

The method may be one wherein the 3D virtual body models are dressed in garments and ordered according to one or more of the following criteria: Garments that are most liked; Garments that are newest; Garments of the same type/category/style/trend as a predefined garment; Garments that have the user's preferred size available; Garments of the same brand/retailer as a predefined garment; sorted from the most recently visited garment to the least recently visited garment.

The method may be one wherein a user can build up their own crowd and use it to store a wardrobe of preferred outfits.

The method may be one wherein a user interface is provided which is usable to display the results from an outfit search engine.

The method may be one wherein the method includes a method of any of aspect according to the first aspect of the invention.

According to a sixth aspect of the invention, there is provided a computing device including a screen and a processor, the computing device configured to generate a plurality of 3D virtual body models, each 3D virtual body model combined with a respective different 3D garment image, and to display the plurality of 3D virtual body models, each combined with the respective different 3D garment image, in a single scene, on the screen of the computing device, in which the processor:

(a) generates the plurality of 3D virtual body models;

(b) generates the respective different 3D garment images for superimposing on the plurality of 3D virtual body models;

(c) superimposes the respective different 3D garment images on the plurality of 3D virtual body models, and

(d) shows on the screen in a single scene the respective different 3D garment images superimposed on the plurality of 3D virtual body models.

The computing device may be configured to perform a method of any aspect according to a fifth aspect of the invention.

According to a seventh aspect of the invention, there is provided a server including a processor, the server configured to generate a plurality of 3D virtual body models, each 3D virtual body model combined with a respective different 3D garment image, and to provide for display the plurality of 3D virtual body models, each combined with the respective different 3D garment image, in a single scene, in which the processor:

(a) generates the plurality of 3D virtual body models;

(b) generates the respective different 3D garment images for superimposing on the plurality of 3D virtual body models;

(c) superimposes the respective different 3D garment images on the plurality of 3D virtual body models, and

(d) provides for display in a single scene the respective different 3D garment images superimposed on the plurality of 3D virtual body models.

The server may be configured to perform a method of any aspect according to a fifth aspect of the invention.

According to a eighth aspect of the invention, there is provided a computer program product executable on a computing device including a processor, the computer program product configured to generate a plurality of 3D virtual body models, each 3D virtual body model combined with a respective different 3D garment image, and to provide for display the plurality of 3D virtual body models, each combined with the respective different 3D garment image, in a single scene, in which the computer program product is configured to:

(a) generate the plurality of 3D virtual body models;

(b) generate the respective different 3D garment images for superimposing on the plurality of 3D virtual body models;

(c) superimpose the respective different 3D garment images on the plurality of 3D virtual body models, and

(d) provide for display in a single scene the respective different 3D garment images superimposed on the plurality of 3D virtual body models.

The computer program product may be configured to perform a method of any aspect according to a fifth aspect of the invention.

According to a ninth aspect of the invention, there is provided a method for generating a 3D virtual body model of a person combined with a 3D garment image, and displaying the 3D virtual body model of the person combined with the 3D garment image on a screen of a mobile computing device, in which:

(a) the 3D virtual body model is generated from user data;

(b) a garment selection is received;

(c) a 3D garment image is generated of the selected garment, and

(d) the 3D garment image is shown on the screen super-imposed over the 3D virtual body model.

The method may be one in which garment size and fit advice is provided, and the garment selection, including a selected size, is received.

The method may be one in which the 3D garment image is generated by analysing and processing one or multiple 2D photographs of the garment.

The method may be one in which an interface is provided on the mobile computing device for a user to generate a new user account, or to sign in via a social network.

The method may be one in which the user can edit their profile.

The method may be one in which the user can select their height and weight.

The method may be one in which the user can select their skin tone.

The method may be one in which the user can adjust their waist and hip size.

The method may be one in which the method includes a method for generating a plurality of 3D virtual body models, each 3D virtual body model combined with a respective different 3D garment image, and displaying the plurality of 3D virtual body models, each combined with the respective different 3D garment image, in a single scene, on the screen of the mobile computing device, the method including the steps of:

(a) generating the plurality of 3D virtual body models;

(b) generating the respective different 3D garment images for superimposing on the plurality of 3D virtual body models;

(c) superimposing the respective different 3D garment images on the plurality of 3D virtual body models, and

(d) showing on the screen in a single scene the respective different 3D garment images superimposed on the plurality of 3D virtual body models.

The method may be one in which an icon is provided for the user to ‘like’ an outfit displayed on a 3D body model.

The method may be one in which by selecting a 3D body model, the user is taken to a social view of that particular look.

The method may be one in which the user can see who created that particular outfit and reach the profile view of the user who created that particular outfit.

The method may be one in which the user can write a comment on that outfit.

The method may be one in which the user can ‘Like’ the outfit.

The method may be one in which the user can reach a ‘garment information’ view.

The method may be one in which the user can try the outfit on their own 3D virtual body model.

The method may be one in which because the body measurements for the user's 3D virtual body model are registered, the outfit is displayed as how it would look on the user's body shape.

The method may be one in which there is provided a scrollable section displaying different types of selectable garments and a section displaying items that the 3D virtual body model is wearing or has previously worn.

The method may be one in which the screen is a touch screen.

The method may be one in which the 3D virtual body model can be tapped several times and in so doing rotates in consecutive rotation steps.

The method may be one in which the user can select to save a look.

The method may be one in which after having saved a look the user can choose to share it with social networks.

The method may be one in which the user can use hashtags to create groups and categories for their looks.

The method may be one in which a parallax view is provided with 3D virtual body models belonging to the same category as a new look created.

The method may be one in which a menu displays different occasions; selecting an occasion displays a parallax crowd view with virtual avatars belonging to that particular category.

The method may be one in which a view is available from a menu in the user's profile view, which displays one or more of: a parallax view showing the outfits the user has created together with statistics showing the number of looks the user has, the number of likes on different outfits, the number of followers and how many people the user is following.

The method may be one in which selecting followers displays a list of all the people following the user together with the option to follow them back.

The method may be one in which there is provided an outfitting recommendation mechanism, which provides the user with a list of garments which are recommended to combine with the garment(s) the user's 3D virtual body model is wearing.

The method may be one in which recommendation is on an incremental basis and it is approximately modelled by a first-order Markov model.

The method may be one in which for each other user who has appeared in the outfitting history, the frequency of each other user's outfitting record is weighted based on the similarity of the current user and each other user; then the weights of all similar body shapes are accumulated for recommendation.

The method may be one in which a mechanism is used in which the older top-ranking garment items are slowly expired, tending to bring more recent garment items into the recommendation list.

The method may be one in which recommendations are made based on other garments in a historical record which are similar to a current garment.

The method may be one in which a recommendation score is computed for every single garment in a garment database, and then the garments are ranked to be recommended based on their recommendation scores.

The method may be one in which the method includes a method of any aspect according to a first aspect of the invention, or any aspect according to a fifth aspect of the invention.

According to a tenth aspect of the invention, there is provided a system including a server and a mobile computing device in communication with the server, the computing device including a screen, and a processor, in which the system generates a 3D virtual body model of a person combined with a 3D garment image, and displays the 3D virtual body model of the person combined with the 3D garment image on the screen of the mobile computing device, in which the server

(a) generates the 3D virtual body model from user data;

(b) receives a garment selection from the mobile computing device;

(c) generates a 3D garment image of the selected garment,

(d) superimposes the 3D garment image over the 3D virtual body model, and transmits an image of the 3D garment image superimposed over the 3D virtual body model to the mobile computing device,

and in which the mobile computing device

(e) shows on the screen the 3D garment image super-imposed over the 3D virtual body model.

The system may be configured to perform a method of any aspect according to a ninth aspect of the invention.

According to an eleventh aspect of the invention, there is provided a method for generating a 3D garment image, and displaying the 3D garment image on a screen of a computing device, the method including the steps of:

(a) for a 2D torso-based garment model with a single 2D texture cut-out or silhouette, the 3D geometry model of the garment is approximated by applying the following simplifications: around the upper body, the garment closely follows the geometry of the underlying body shape; around the lower body, the garment approximates to an elliptic cylinder with varying axis lengths, centred at the origin of the body;

(b) showing on the screen the 3D garment image.

An example implementation is in a digital media player and microconsole, which is a small network appliance and entertainment device to stream digital video/audio content to a high definition television set. An example is Amazon Fire TV.

The method may be one wherein the computing device includes a sensor system, including the steps of:

(c) detecting a position change using the sensor system, and

(d) showing on the screen the 3D garment image, modified in response to the position change detected using the sensor system.

The method may be one for generating a 3D virtual body model of a person combined with the 3D garment image, including the steps of:

(e) generating the 3D virtual body model;

(f) showing on the screen the 3D garment image on the 3D virtual body model.

The method may be one including the steps of: generating a smooth 3D mesh with faces from a point cloud of vertices given by depth approximations at each pixel, and generating a final normalised depth map of the garment for a required view.

The method may be one wherein the depth map is used to calculate the extent to which a given point on the garment texture needs to move in the image in order to simulate an out-of-plane rotation about the vertical axis.

The method may be one wherein an underlying head and neck base geometry of the user's 3D body shape model is used as an approximate 3D geometry and modeling a 3D rotation of the head sprite/hairstyle from a single 2D texture image using an approach of 2D texture morphing and morph field extrapolation is performed.

According to an twelfth aspect of the invention, there is provided a system including a server and a computing device in communication with the server, the computing device including a screen, a sensor system and a processor, the server configured to generate a 3D virtual body model of a person combined with a 3D garment image, and to transmit to the computing device an image of the 3D virtual body model of the person combined with the 3D garment image, in which the server:

(a) generates the 3D virtual body model;

(b) generates the 3D garment image for superimposing on the 3D virtual body model;

(c) superimposes the 3D garment image on the 3D virtual body model;

(d) transmits the image of the superimposed the 3D garment image on the 3D virtual body model to the computing device;

and in which the computing device:

(e) shows on the screen the 3D garment image superimposed on the 3D virtual body model;

(f) detects a position change using the sensor system, and

(g) transmits to the server a request for a 3D garment image superimposed on the 3D virtual body model, modified in response to the position change detected using the sensor system;

and in which the server

(h) transmits an image manipulation function (or parameters for one) relating to an image of the superimposed 3D garment image on the 3D virtual body model to the computing device, modified in response to the position change detected using the sensor system;

and in which the computing device:

(i) applies the image manipulation function to the image of the 3D garment image superimposed on the 3D virtual body model, and shows on the screen the 3D garment image superimposed on the 3D virtual body model, modified in response to the position change detected using the sensor system.

The system may be one configured to perform a method according to any aspect of the first aspect of the invention.

### BRIEF DESCRIPTION OF THE FIGURES

Aspects of the invention will now be described, by way of example(s), with reference to the following Figures, in which:

FIG. 1 shows an example of a workflow of an account Creation/Renewal process.

FIG. 2 shows an example of a create account screen.

FIG. 3 shows an example of a login screen for an existing user.

FIG. 4 shows an example in which a user has signed up through a social network, so the name, email and password are automatically filled in.

FIG. 5 shows an example of a screen in which the user may fill in a name and choose a username.

FIG. 6 shows an example of a screen in which the user may add or change their profile picture.

FIG. 7 shows an example of a screen in which the user may change their password.

FIG. 8 shows an example of a screen after which a user has filled in details.

FIG. 9 shows an example of a screen for editing user body model measurements.

FIG. 10 shows an example of a screen presenting user body model measurements, such as for saving.

FIG. 11 shows an example of a screen providing a selection of models with different skin tones.

FIG. 12 shows an example of a screen in which the user can adjust waist and hip size on their Virtual avatar.

FIG. 13 shows an example of a screen in which saving the profile and body shape settings takes the user to the ‘all occasions’ view.

FIG. 14 shows examples of different views which may be available to the user, in a flowchart.

FIG. 15 shows examples of different crowd screens.

FIG. 16 shows an example of a social view of a particular look.

FIG. 17 shows an example of a screen which displays the price of garments, where they can be bought and a link to the online retailers who sell them.

FIG. 18 shows an example of screens which display product details.

FIG. 19 shows an example of a screen which shows what an outfit looks like on the user's own virtual avatar.

FIG. 20 shows examples of screens which may include a scrollable section displaying different types of selectable garments and a section displaying items that the virtual avatar is wearing or has previously worn.

FIG. 21 shows an example of a screen in which a user can select an option to save the look.

FIG. 22 shows examples of screens in which a user can give a look a name together with a category.

FIG. 23 shows examples of screens in which a user can share a look.

FIG. 24 shows examples of screens in which a menu displays different occasions; tapping on an occasion may display a parallax crowd view with virtual avatars belonging to that particular category.

FIG. 25 shows examples of screens of a user's profile view.

FIG. 26 shows an example screen of another user's profile.

FIG. 27 shows an example of a user's edit my profile screen.

FIG. 28 shows an example of a screen for starting a completely new outfit.

FIG. 29 shows an example of a screen showing a ‘my saved look’.

FIG. 30 shows an example of screens for making a comment.

FIG. 31 shows an example of screens displaying horizontal parallax view when scrolled.

FIG. 32 shows an example in which a virtual avatar can be tapped several times and in so doing rotate in consecutive rotation steps.

FIG. 33 shows an example of the layout of the “Crowd” user interface. The user interface may be used in profile or landscape aspect.

FIG. 34 shows an example of a “Crowd” user interface on a mobile-platform e.g. iPhone 5S.

FIG. 35 shows an example of a user flow of a “Crowd” user interface.

FIG. 36 shows an example mock-up implementation of horizontal relative movement. The scene contains 3 depth layers of virtual avatars. The first layer moves with the drag speed; the second layer moves with drag speed/1.5; the third layer moves with drag speed/3. All renders are modelled on the average UK woman (160 centimetres and 70 kilograms).

FIG. 37 shows a schematic example of a scene scrolling UI feature by swiping left or right.

FIG. 38 shows an example of integrating social network features, e.g. rating, with the “Crowd” user interface.

FIG. 39 shows an example user interface which embeds garment and style recommendation features with the “Crowd” user interface.

FIG. 40 shows example ranking mechanisms when placing avatars in the crowd. Once the user has entered a crowd, the crowd will have to be ordered in some way from START to END.

FIG. 41 shows a zoomed-out example of the whole-scene rotation observed as the user's head is moved from left to right. Normal use would not have the edges of the scene visible, but they are shown here to illustrate the extent of whole-scene movement.

FIG. 42 shows an example of left-eye/right-eye parallax image pair generated by an application or user interface. They can be used for stereo visualisation with a 3D display device.

FIG. 43 shows an example of a Main screen (left) and Settings screen (right).

FIG. 44 shows an example side cross-section of s 3D image layout. Note that b, h, and d are values given in pixel dimensions.

FIG. 45 shows an example separation of a remote vertical background and floor images from an initial background.

FIG. 46 shows a plan view of relevant dimensions for viewing angle calculations when a face tracking module is used.

FIG. 47 shows an example of an end to end process of rendering 2D texture images of an arbitrarily rotated virtual avatar.

FIG. 48 shows an example of a plan section around the upper legs, with white dots indicating the body origin depth sample points and the black elliptical line indicating the outline of the approximated garment geometry for a garment that is tight fitting.

FIG. 49 shows an example of 3D geometry creation from a garment silhouette in the front-right view.

FIG. 50 shows example ellipse equations in terms of the horizontal pixel position x and corresponding depth y.

FIG. 51 shows an example of a sample 3D geometry for complex garments. An approximate 3D geometry is created from the garment silhouette for each garment layer corresponding to each individual body part.

FIG. 52 shows an example of an approach to approximately model the 3D rotation of a 2D head sprite or 2D hairstyle image when the explicit 3D geometry is not present.

### DETAILED DESCRIPTION

### Overview

We introduce a number of user interfaces for virtual body shape and outfitting visualisation, size and fit advice, and garment style recommendation, which help improve users' experience in online fashion and e-commerce. As typical features, these user interfaces 1) display one or more 3D virtual avatars which are rendered by a body shape and outfitting visualisation engine, into a layout or scene with interactive controls, 2) provide users with new interactive controls and visual effects (e.g. 3D parallax browsing, parallax and dynamic perspective effects, stereo visualisation of the avatars), and 3) embed a range of different recommendation features, which will ultimately enhance a user's engagement in the online fashion shopping experience, help boost sales, and reduce returns.

As a summary, the following three user interfaces are disclosed:
The “Wanda” User Interface

A unified and compact user interface that integrates a user's body shape visualisation, outfitting, garment size and fit advice, and social network and recommendation features.
The “Crowd” User Interface

A user interface with a crowd of virtual avatars shown to the user. These people/avatars can be in different outfits, have different body shapes, and may be shown from different view angles. A number of visual effects (e.g. 3D parallax browsing) and recommendation features may be associated with this user interface. The user interface can for example be implemented on both a desktop computer and on a mobile platform.
Dynamic Perspective User Interface

This user interface generates a user experience in which one is given the feeling of being able to move around the sides of the virtual avatar for example by either moving one's head around the mobile phone, or simply turning the phone in one's hand. In an example, the user interface may be used to generate stereo image pairs of the virtual avatar in a 3D scene for 3D display.

Technical details and underlying algorithms to support the features of the above user interfaces are detailed in the remaining sections.

This document describes applications that may run on a mobile phone or other portable computing device. The applications or their user interfaces may allow the user to
Create their own model and sign up
Browse a garment collection, eg. arranged into outfits on a single crowd view
Tap on an outfit to see the garments
Try an outfit on your own model
Tap on a garment to register your interest in later purchase (for items which are not yet on sale)
View a related Catwalk video
Choose to view a second crowd view with an older collection
Proper outfitting (restyling and editing)
Creating and sharing models
Liking or rating outfits

The applications may be connected to the internet. A user may access all or some of the content also from a desktop application.

An application may ask a user to rotate a mobile device (eg. from landscape to portrait, or from portrait to landscape), in order to continue. Such a step is advantageous in ensuring that the user views the content in the most appropriate device orientation for the content to be displayed.

Section 1: The “Wanda” User Interface

The “Wanda” user interface is a unified and compact user interface which integrates virtual body shape visualisation, outfitting, garment size and fit advice, and social network and recommendation features. Major example product features of the Wanda user interface are detailed below.

1.1 Account Creation/Renewal

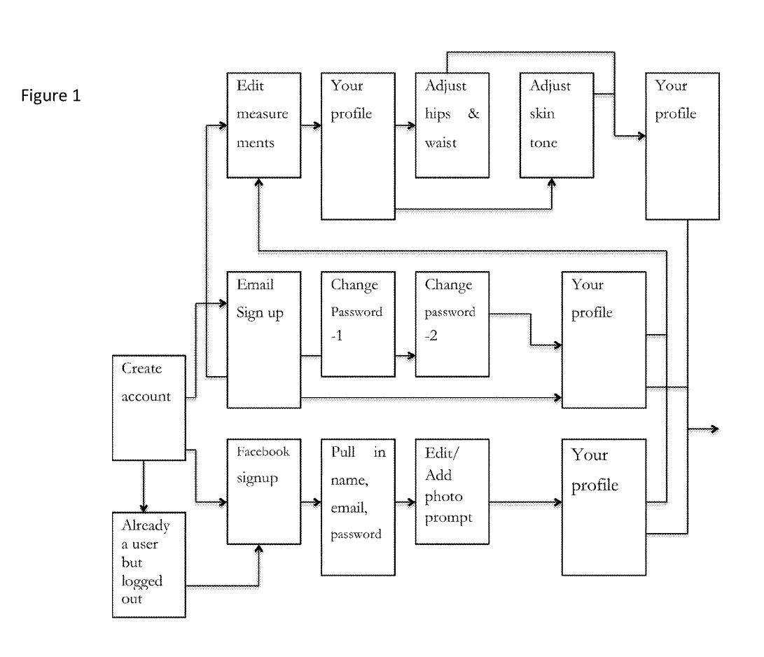

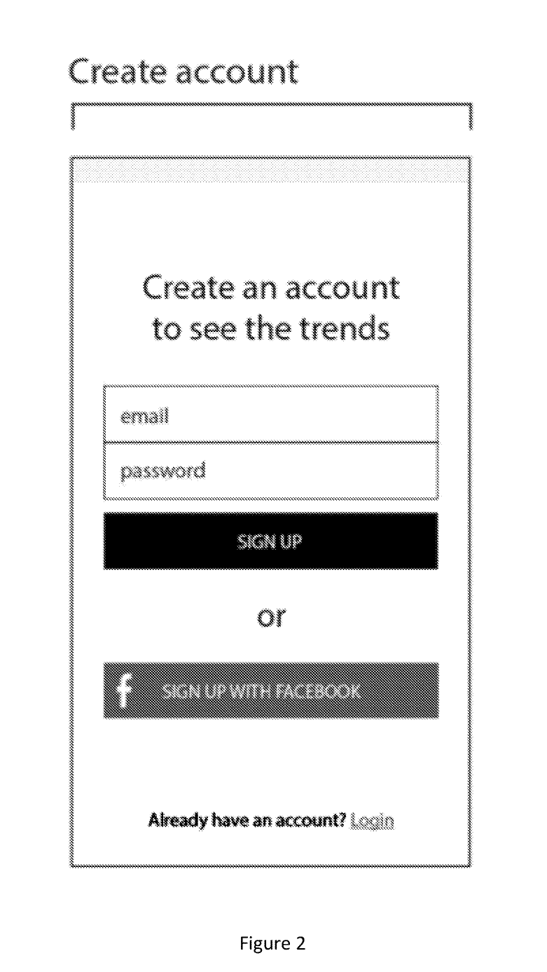

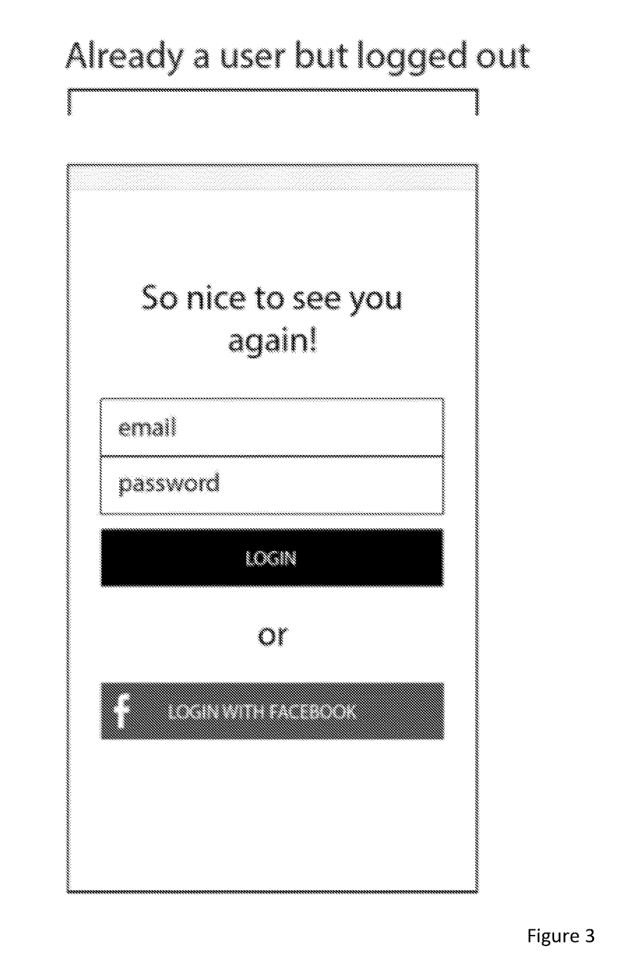

A first thing a user may have to do is to log on, such as to an app or in the user interface, and create a user. An example of a workflow of this process can be seen in FIG. 1. The user may sign up as a new user or via a social network. See FIG. 2 for example. If the user already has an account, they can simply login with their email/username and password. See FIG. 3 for example. Signing in for the first time takes the user to the edit profile view.

1.2 Edit Profile View

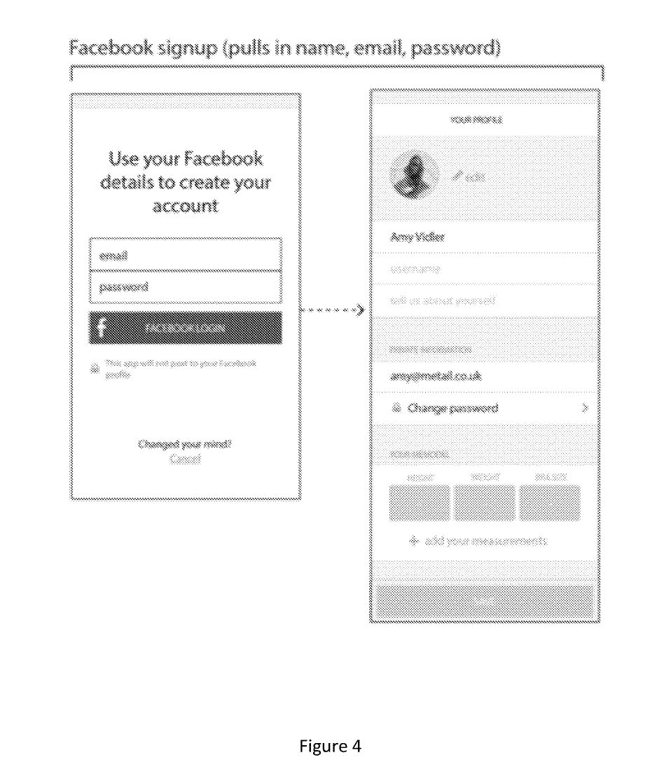

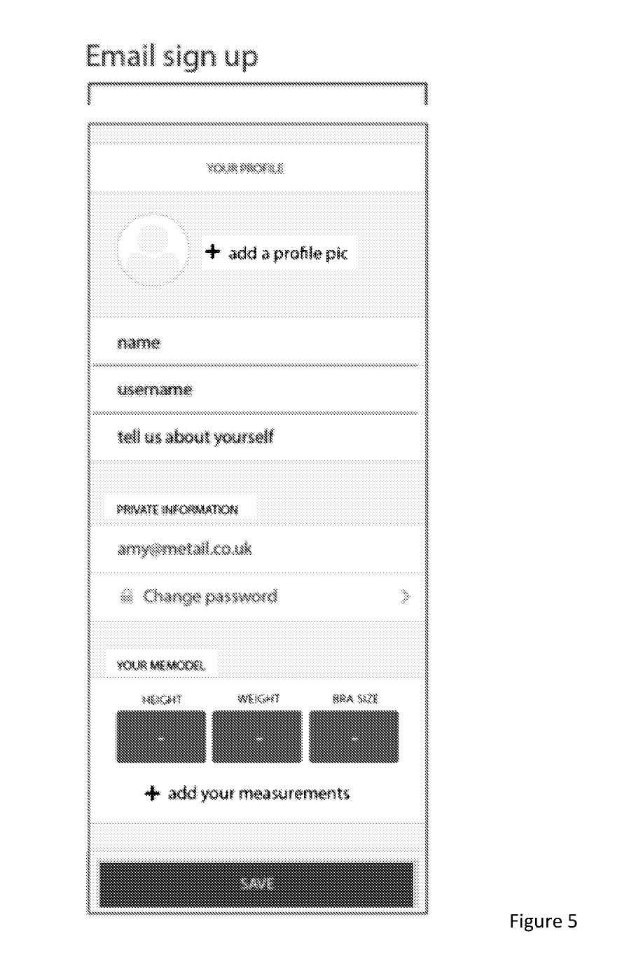

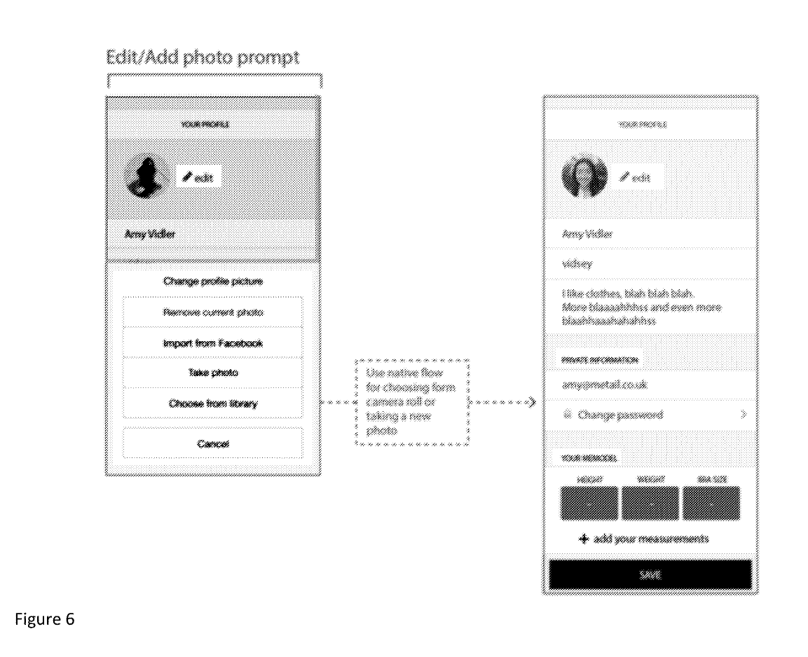

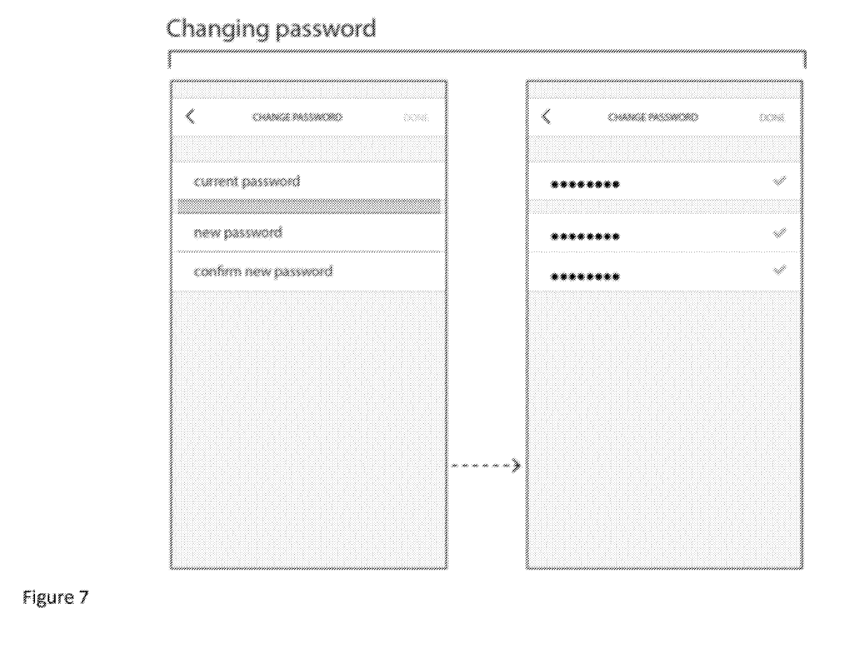

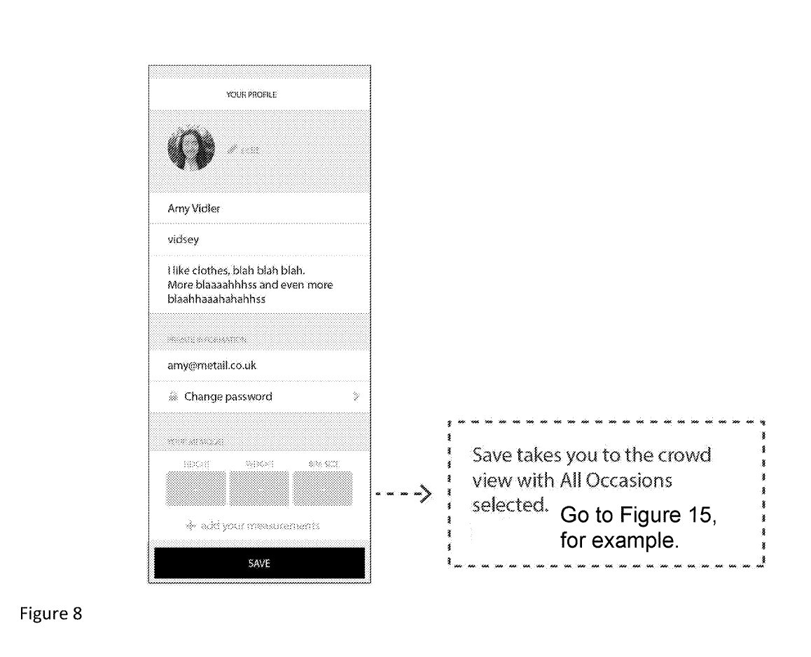

After signing up, the user may fill in a name and choose a username. See FIG. 5 for example. The user may add or change their profile picture. See FIG. 6 for example. The user may add a short description of themselves and choose a new password. See FIG. 7 for example. If a user has signed up through a social network, the name, email and password will be automatically filled in. See FIG. 4 for example. After having filled in the details, regardless of sign up method, the screen may look like one as shown in FIG. 8. The user may also add measurements for their height, weight and bra size which are important details connected to the user's virtual avatar.

1.3 Adding Measurements

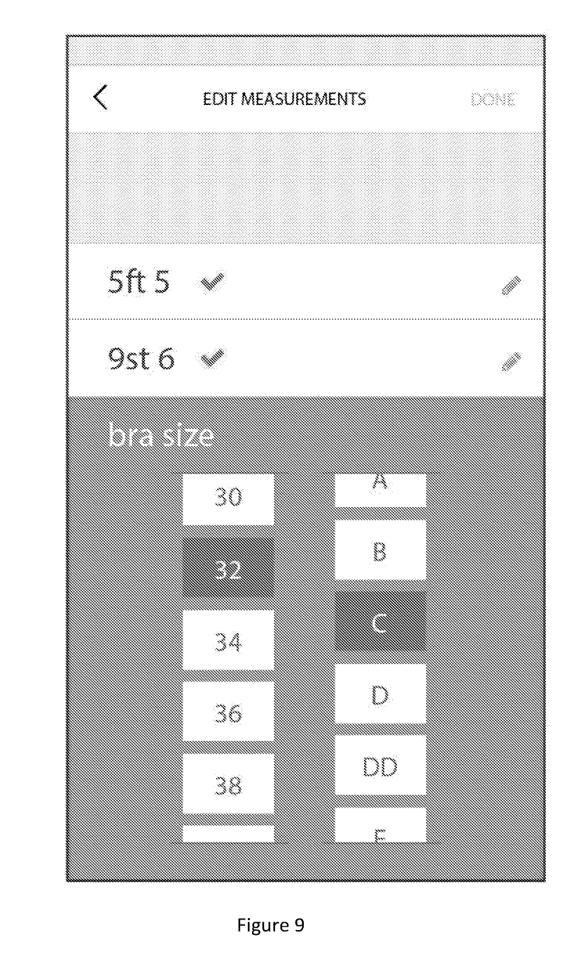

Height, weight and bra size may be shown in a separate view which is reached from the edit profile view. See FIG. 9 for one implementation. Height measurements may be shown in a scrollable list that can display either or both feet and centimetres. Tapping and choosing the suitable height for the user may automatically take the user to the next measurements section.

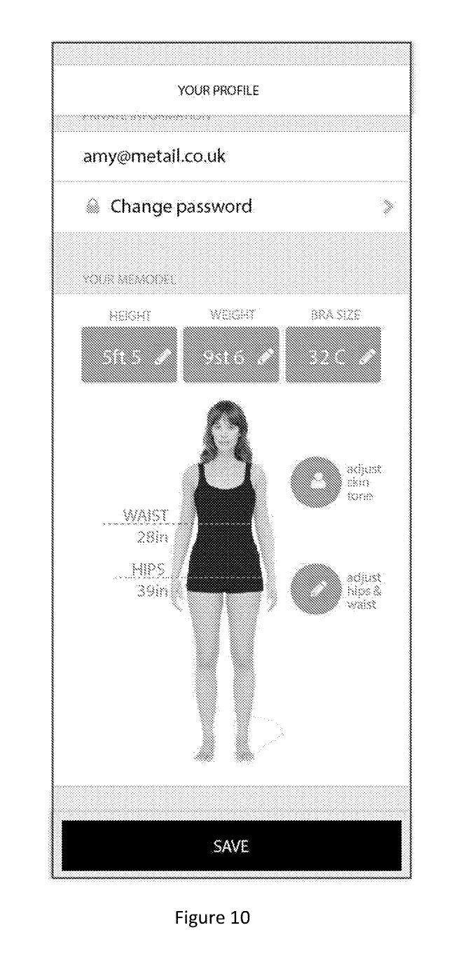

Weight may be shown in either or both stones and kilos, and may be displayed in a scrollable list where the user taps and chooses relevant weight. The user may then automatically be taken to the bra size measurements which may be completed in the same manner as the previous two measurements. See FIG. 10 for example.

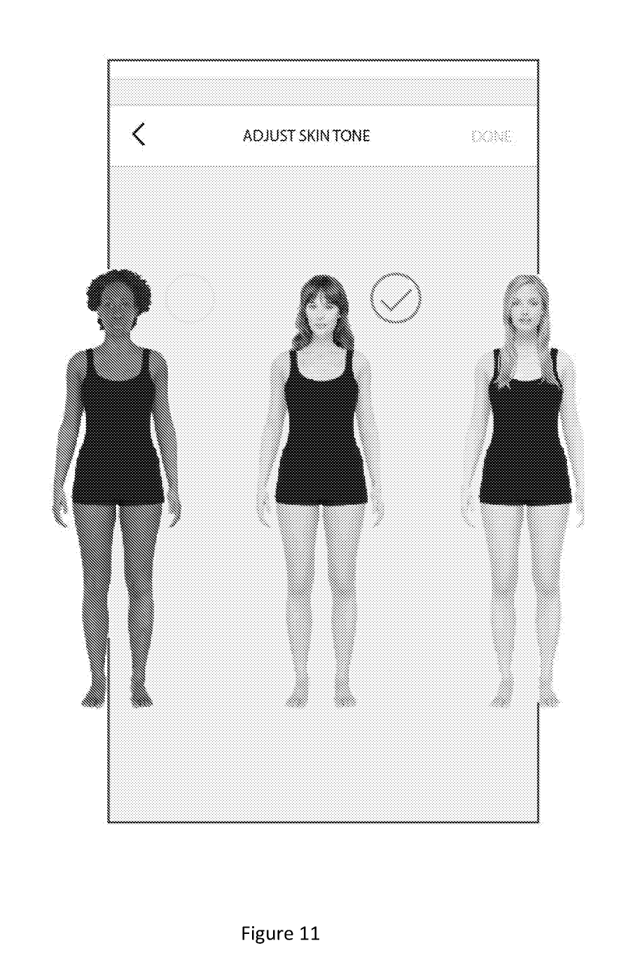

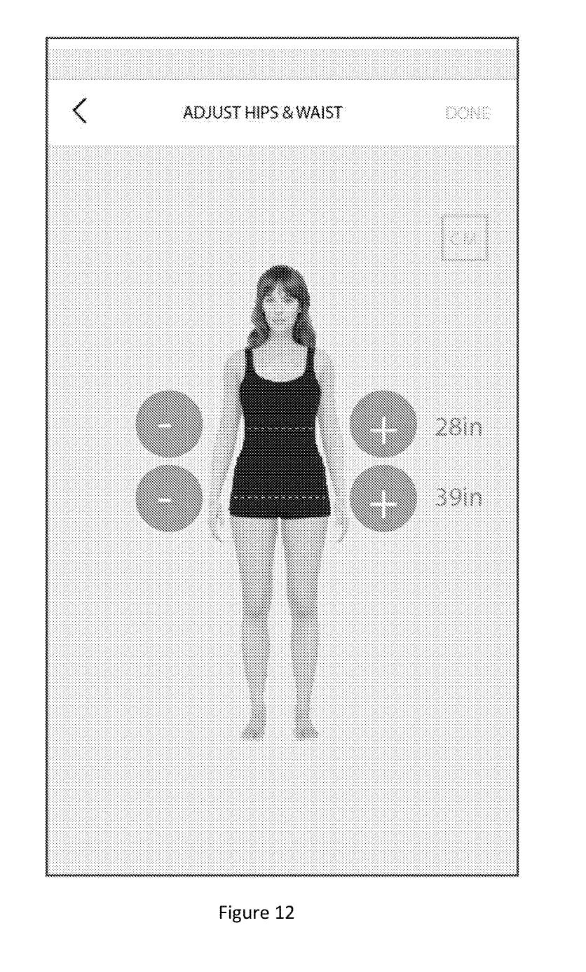

From the edit profile view, the user may reach the settings for adjusting skin tone to their virtual avatars. A selection of models with different skin tones are available where the user can choose whichever model suits them best. See FIG. 11 for example. For further accuracy the user can adjust waist and hip size on their Virtual avatar. The measurements for this can be shown in either or both centimetres and inches. See FIG. 12 for example.

1.4 ‘All Occasions’ View

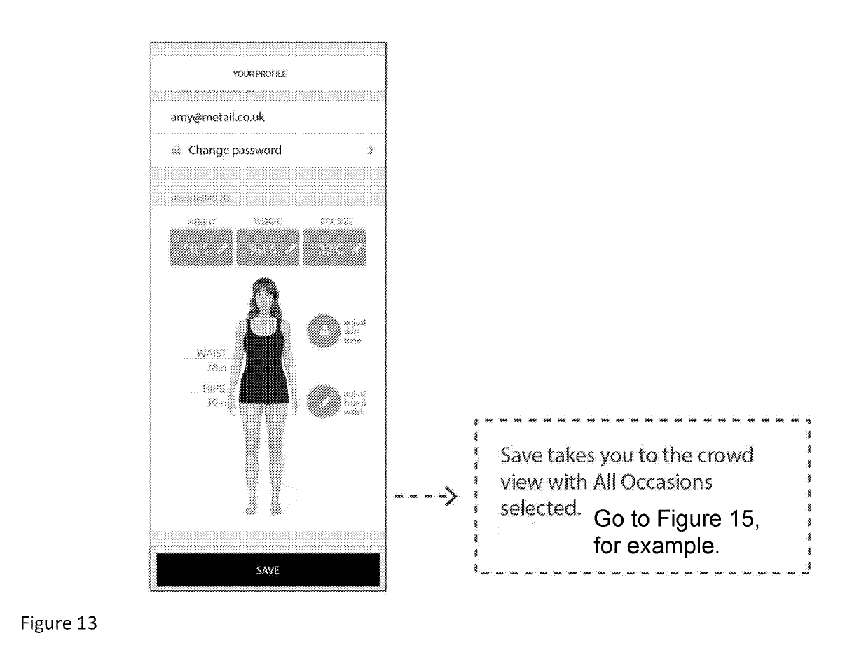

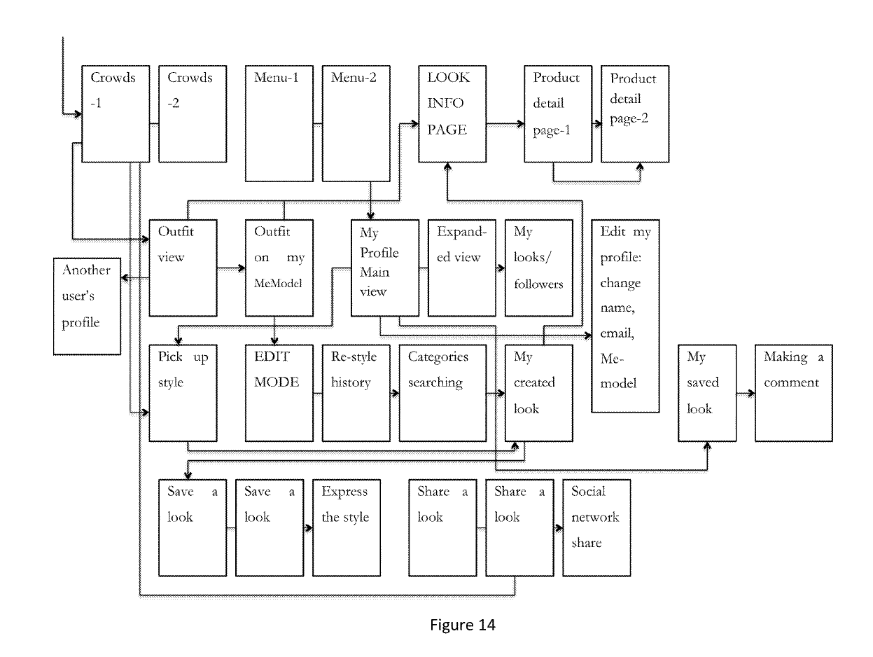

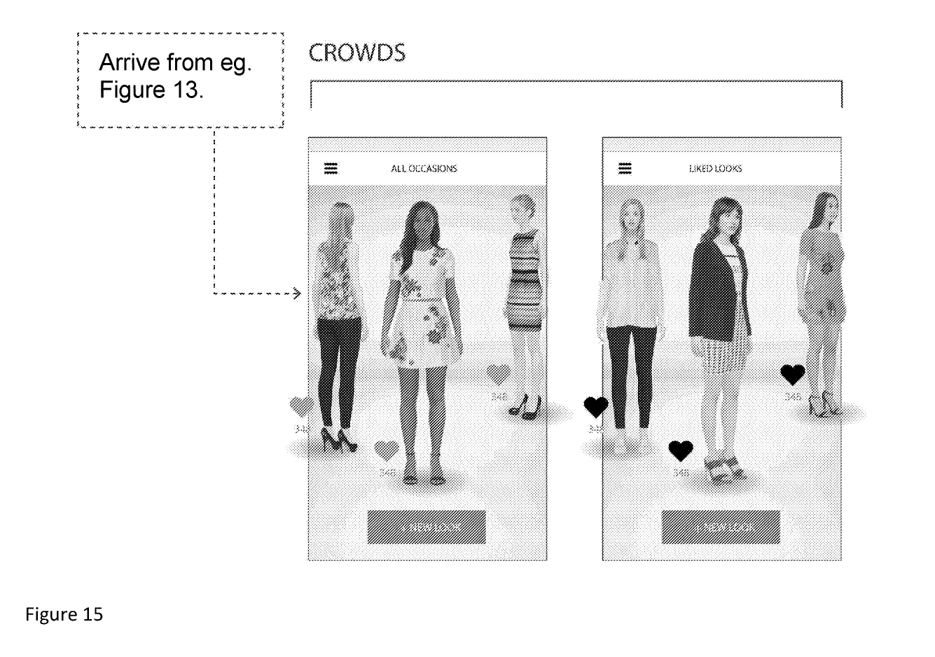

When finished with the profile and body shape settings, saving the profile may take the user to the ‘all occasions’ view. See FIG. 13 and FIG. 15 left hand side, for example. This view is a version of the parallax view which acts as an explorer tab displaying everything that is available in the system. For examples of different views which may be available to the user, see the flowchart in FIG. 14.

1.5 Parallax View

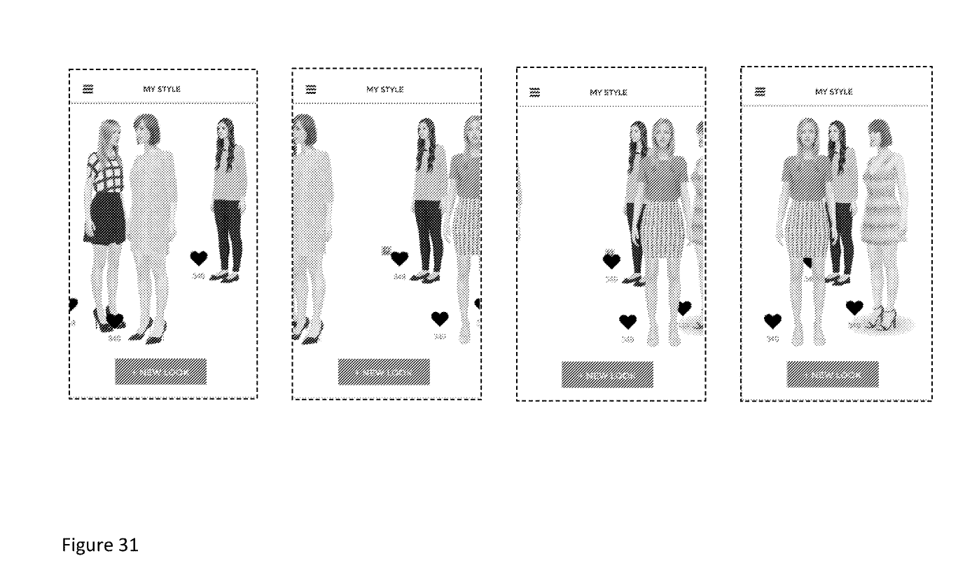

The parallax view can be scrolled horizontally where a variety of virtual avatars wearing different outfits are displayed. FIG. 31 displays one implementation of the horizontal parallax view when scrolled.

Next to the virtual avatars there can be icons. One of the icons which may be available is for the user to ‘like’ an outfit displayed on a virtual avatar. In one implementation this is shown as a clickable heart icon together with the number of ‘likes’ that an outfit has received. See FIG. 15 for example.

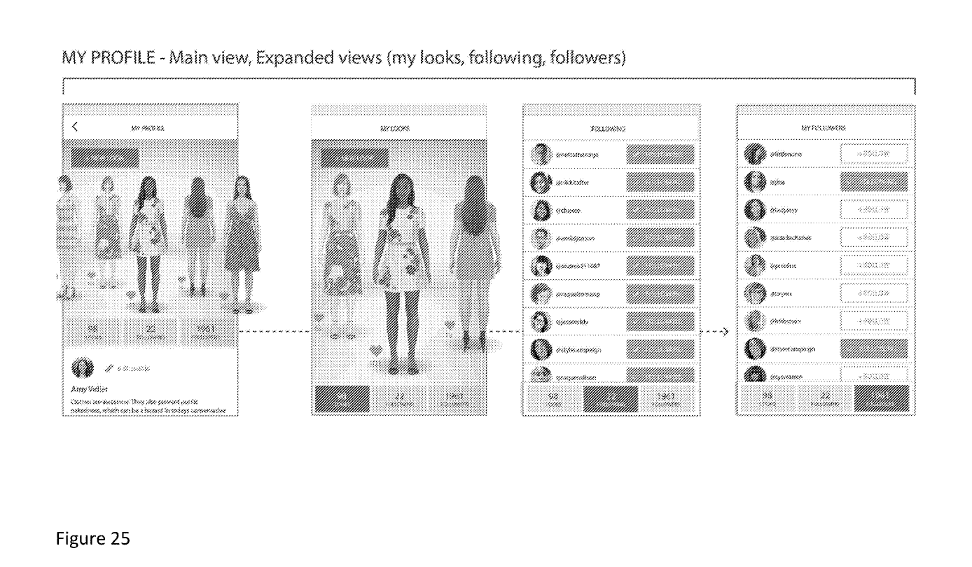

There may be several different parallax views showing crowds of different categories. From any parallax view, a new look may be created such as by choosing to create a completely new look or to create a new look based on another virtual avatar's look. See for example FIG. 15 and FIG. 25.

1.6 Viewing Someone Else's Look

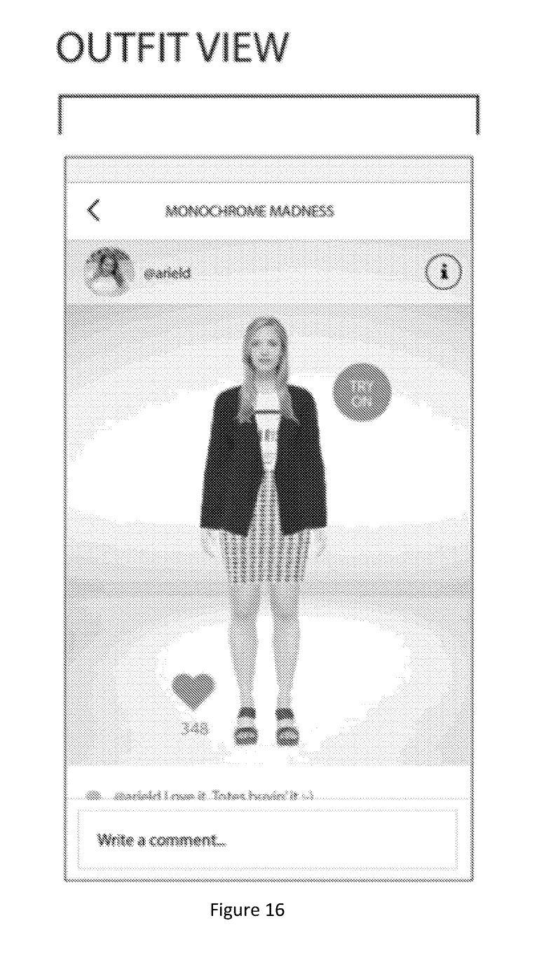

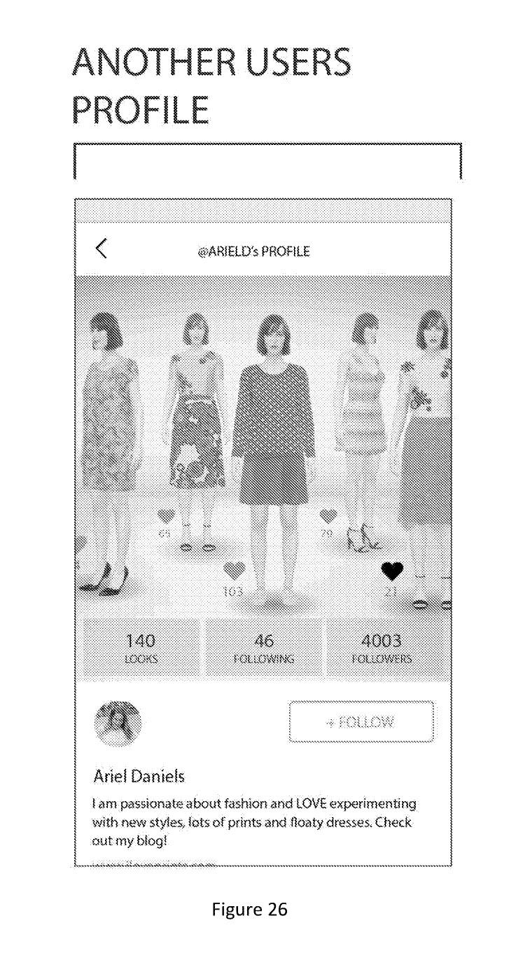

By tapping on an outfit worn by a virtual avatar in a parallax view, the user may be taken to a social view of that particular look. For one implementation, see FIG. 16. From this view the user can for example:
See who created that particular outfit and reach the profile view of that user. See FIG. 26 for an example of another user's profile.
Write a comment on that outfit.
‘Like’ the outfit.
Reach the ‘garment information’ view.
Try the outfit on.

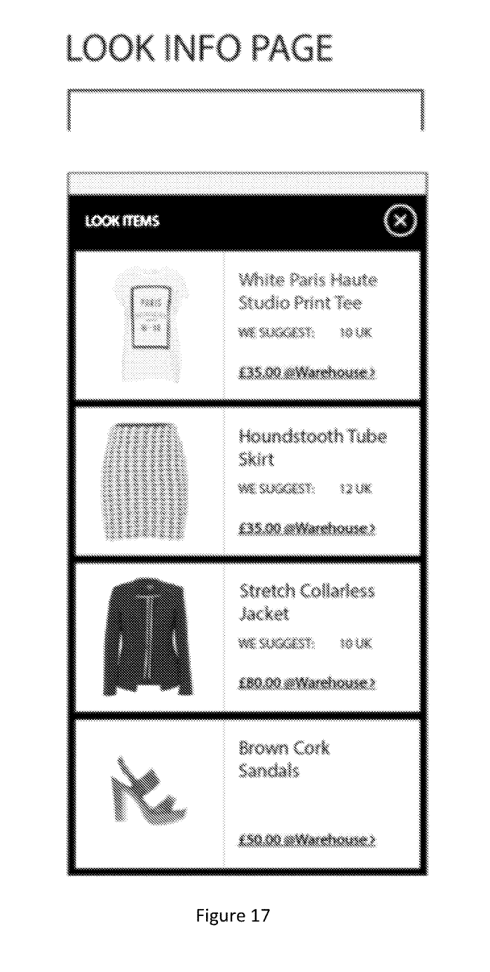

As seen in FIG. 17, the garment information view displays for example the price of the garments, where they can be bought and a link to the online retailers who sell them.

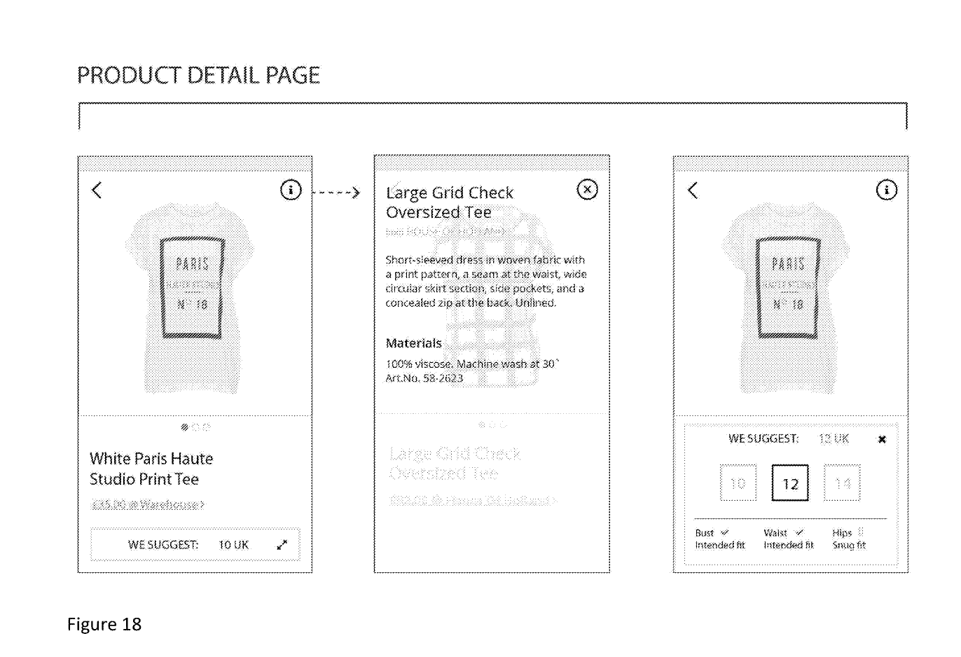

From the Garment information view, a clothes item may be selected which takes the user to a specific view regarding that garment. See FIG. 18 for example. In this view, not only are the price and retailer shown but the app or user interface will also suggest what size it thinks will fit the user best.

If the user selects different sizes, the app or user interface may tell the user how it thinks the garment will fit at the bust, waist, and hips. For example, the app or user interface could say that a size 8 may have a snug fit, a size 10 the intended fit and size 12 a loose fit. The same size could also fit differently over the different body sections. For example it could be snug over the hip but loose over the waist.

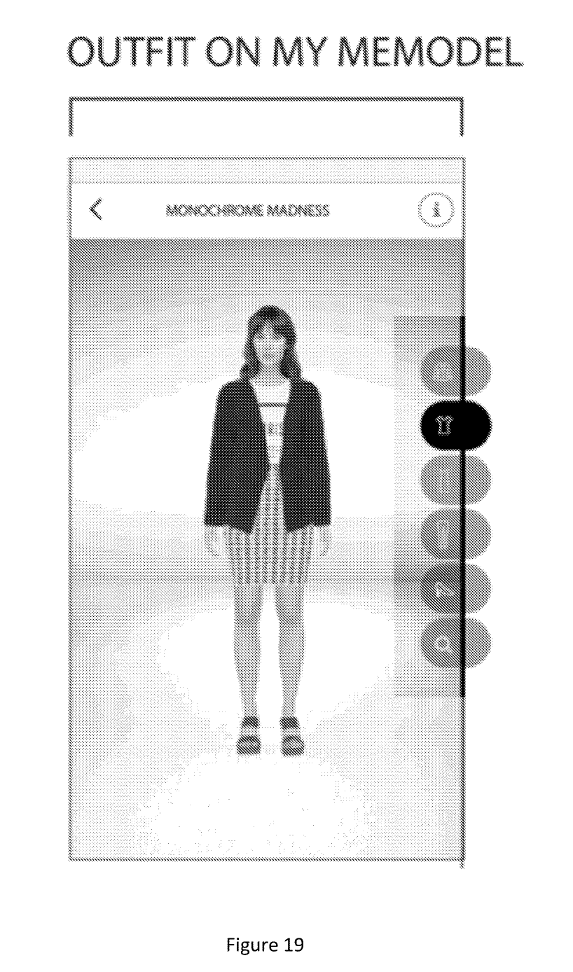

There are different ways for the user to create new looks. To create a new look from a social view, the user may tap the option to try the outfit on. See FIG. 16 for example. This may take the user to a view showing what the outfit looks like on the user's own virtual avatar. See FIG. 19 for example. Because the application already has the body measurements for the user's virtual avatar registered, the outfit will be displayed as how it would look on the user's body shape.

From the same view, the user may reach an edit outfit view either by swiping left or by tapping one of the buttons displayed along the right hand side of the screen.

1.7 Edit Look View

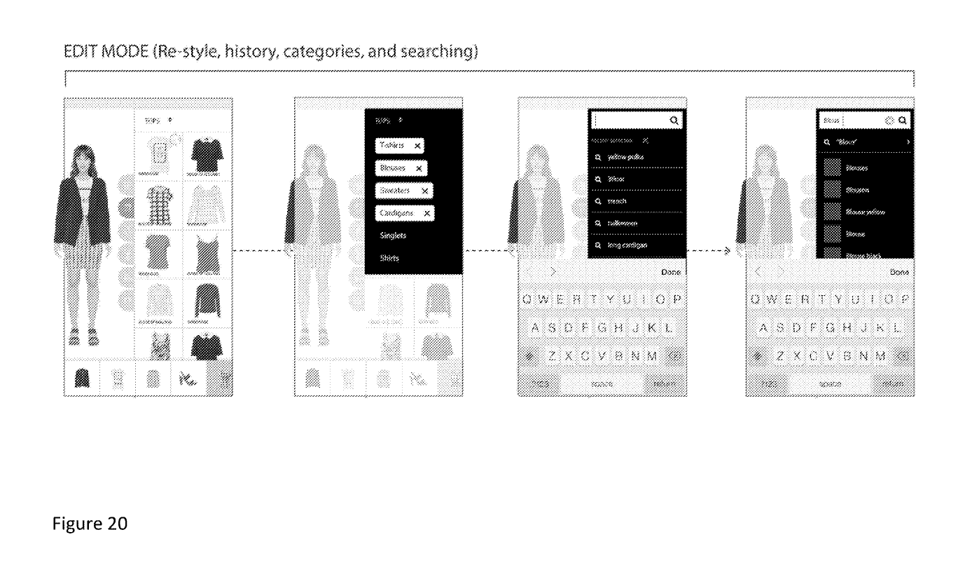

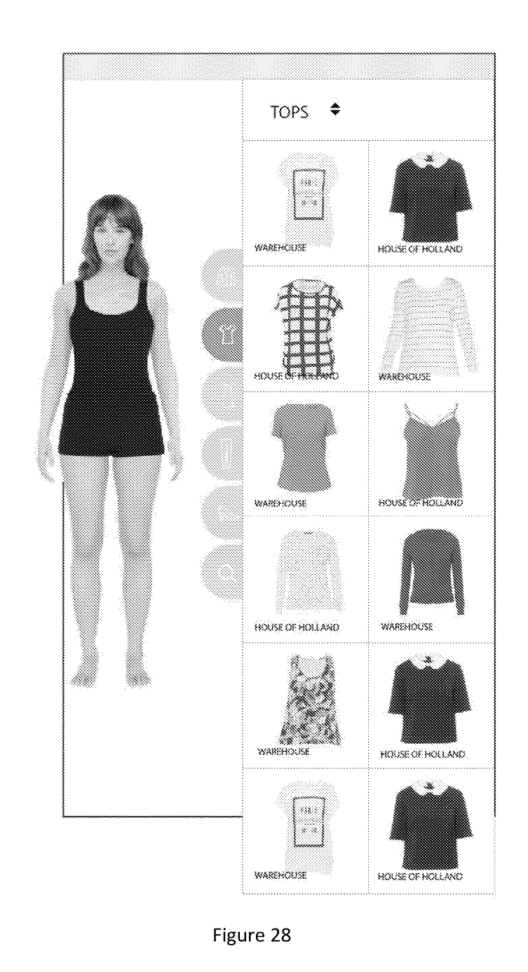

From this view, as shown for example in FIG. 20, the user sees their virtual avatar with the outfit the user wanted to try on. There may be a scrollable section displaying different types of selectable garments and a section displaying items that the virtual avatar is wearing or has previously worn. If the user chooses to start a new outfit then the view and available edit sections would look the same. The only difference would be the pre-determined garments the virtual avatar is wearing. See for example FIG. 28 for starting a completely new outfit.

The section with selectable garments (eg. FIG. 20) lets the user combine different items of clothing with each other. With a simple tap, a garment can be removed as well as added to the virtual avatar. In one implementation, a double tap on a garment will bring up product information of that particular garment.

To the side of the selectable garments there may be a selection of tabs related to garment categories, which may let the user choose what type of garments to browse through, for example coats, tops, shoes.

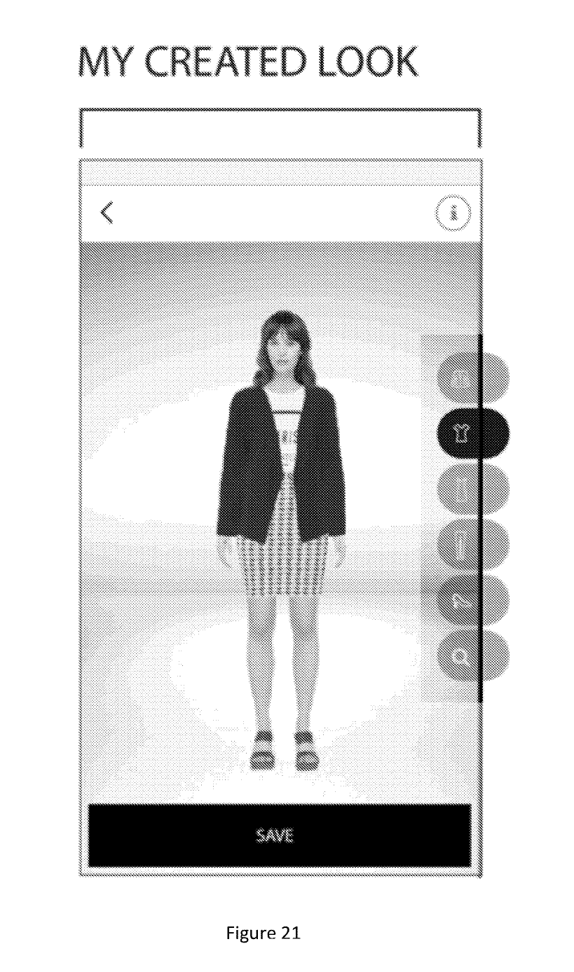

Once the user finishes editing with their outfit they can swipe from left to right to hide the edit view and better display the new edited outfit on the user's virtual avatar. See FIG. 21 for example. Tapping on the virtual avatar may rotate it in 3D, letting the user see the outfit from different angles.

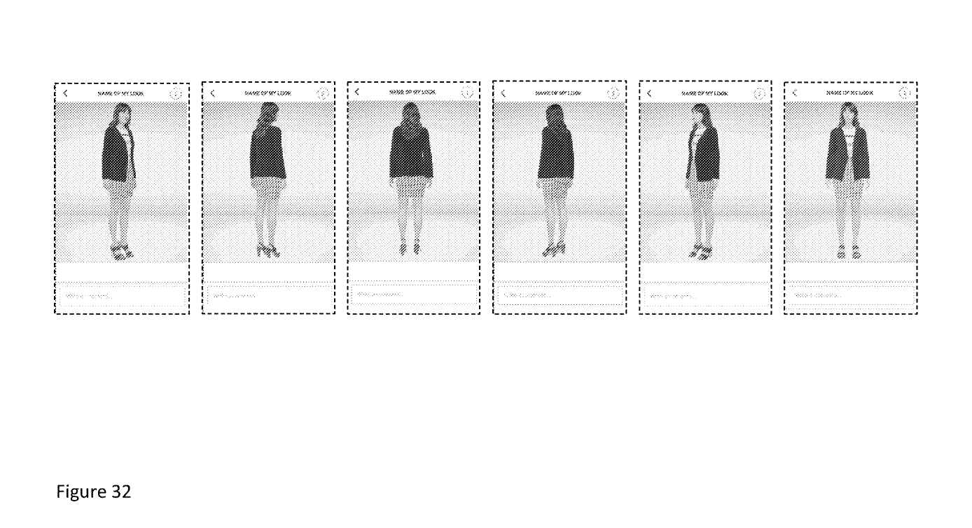

The virtual avatar can be tapped several times and in so doing rotate in consecutive rotation steps, as illustrated for example in FIG. 32. Virtual avatars can be tapped and rotated. Virtual avatars can be tapped and rotated in all views, except in an example for the parallax crowd views.

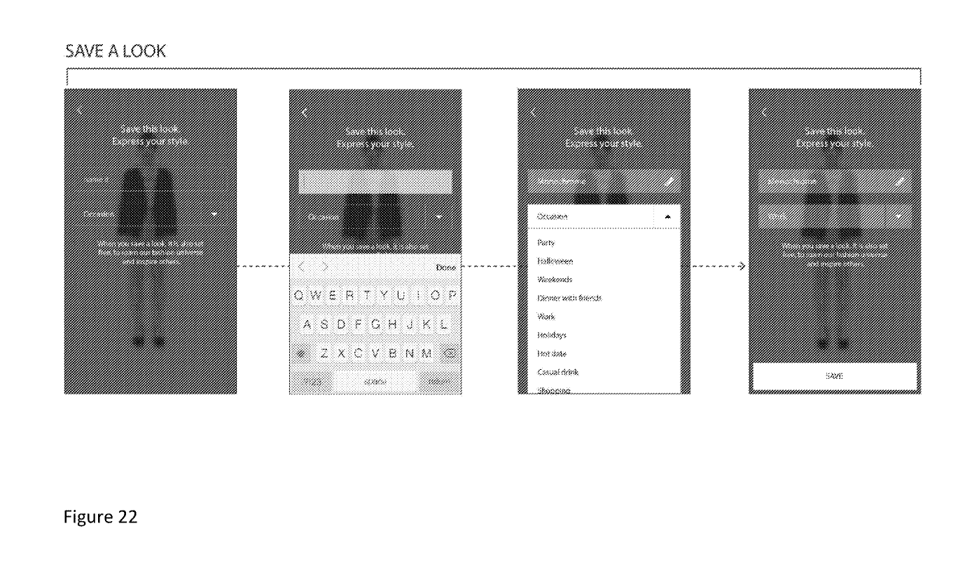

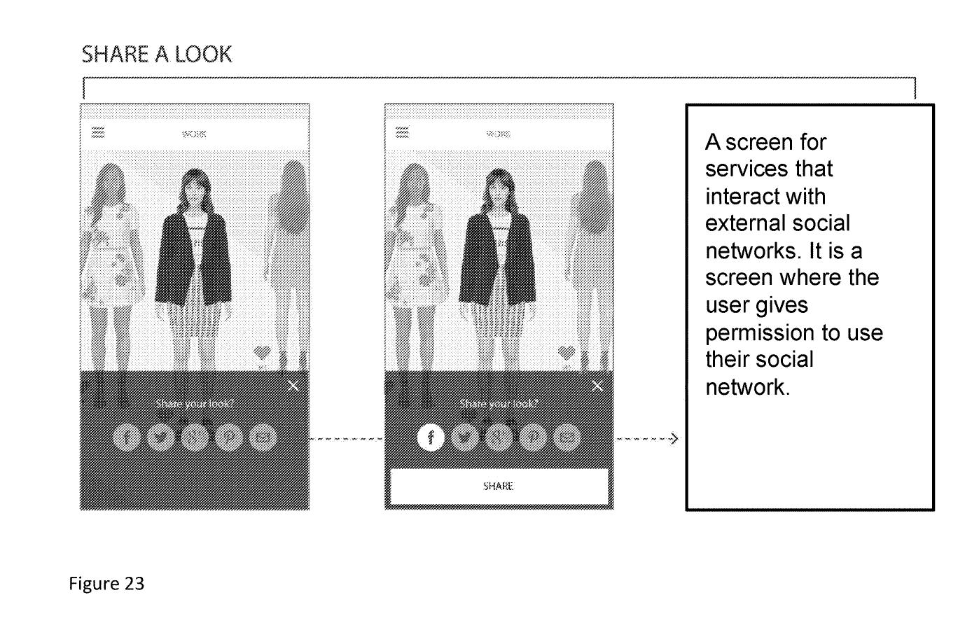

The user can select to save the look. See FIG. 21 for example. The user may give the look a name together with a category e.g. Work, Party, Holiday and so on. An example is shown in FIG. 22. In one implementation, the user can use hashtags to further create groups and categories for their looks. Once the name and occasion have been selected the look can be saved. In doing so the look may be shared with other users. After having saved the look the user can choose to share it with other social networks, e.g. Facebook, Twitter, Google+, Pinterest and email. In one implementation, in the same view as the sharing options there is a parallax view with virtual avatars belonging to the same category as the new look created. An example is shown in FIG. 23.

1.8 Menu

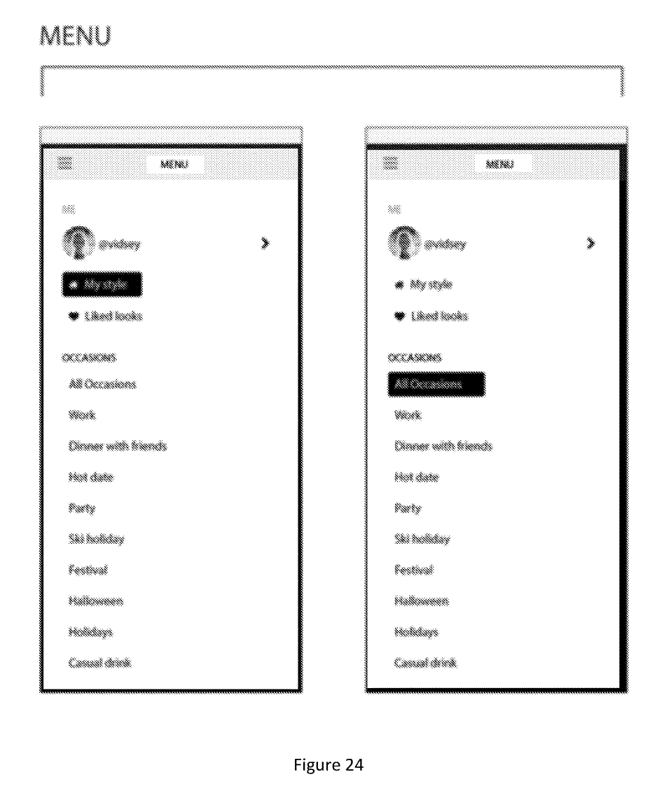

At the top of the screen there is a menu. One implementation of the menu is shown in FIG. 24. The menu displays different occasions; tapping on an occasion may display a parallax crowd view with virtual avatars belonging to that particular category.

The menu also gives access to the user's liked looks where everything the user has liked is collected. See for example FIG. 15, right hand side.

There is access to the user's ‘my style’ section which is a parallax view showing looks that other users have created and which the user is following. The same feed will also show the user's own outfits mixed in with these other followed users' outfits. For one implementation, see FIG. 31.

1.9 Profile View

Another view available from the menu is the user's profile view. The profile view may display a parallax view showing the outfits the user has created together with statistics showing the number of looks the user has, the number of likes on different outfits, the number of followers and how many people the user is following. An example of this is shown in FIG. 25.

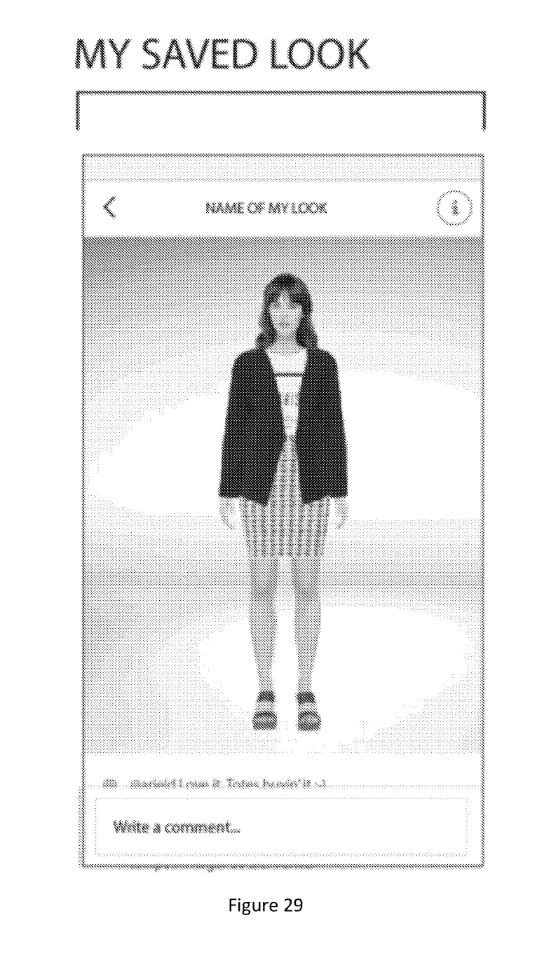

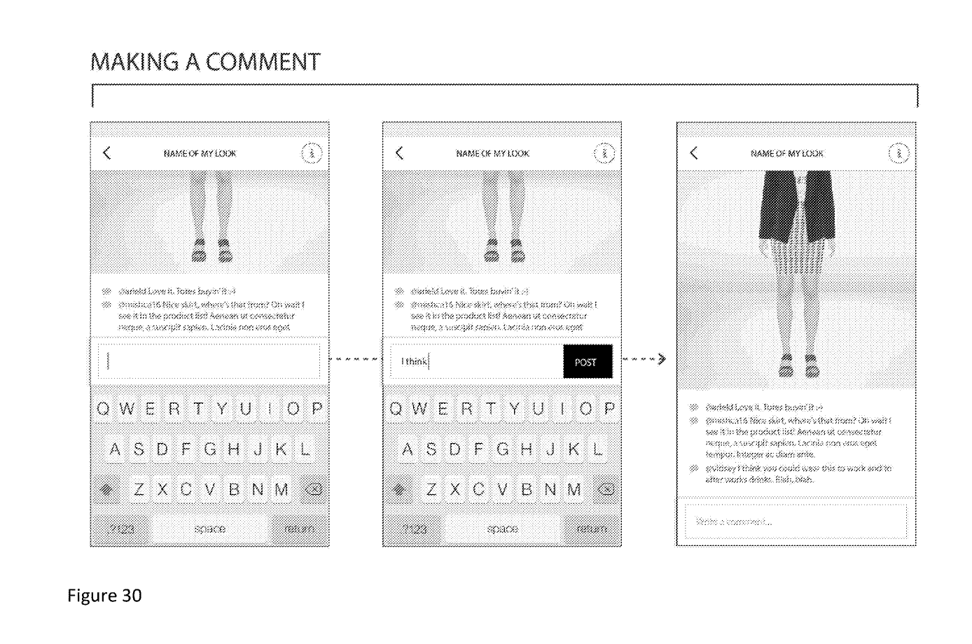

The area displaying the statistics can be tapped to get more information than just a number. For example, tapping on followers displays a list of all the people following the user together with the option to follow them back, or to unfollow (see eg. FIG. 25). The same type of list is shown when tapping on the statistics tab showing who the user is following. Tapping on the number of looks may display a parallax view of the user's created looks. From there, tapping on one of the looks may display another view showing more information of the garments and giving the option to leave a comment about that specific look. See FIG. 29 and FIG. 30, for example. If the user stays in the parallax statistics view (eg. FIG. 25), a swipe up will take the user back to their profile view.

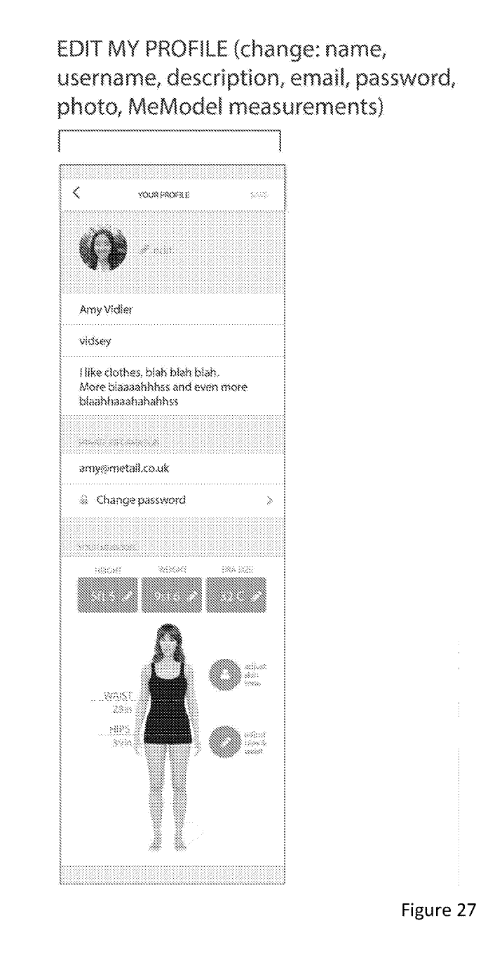

In the profile view (eg. FIG. 25), there is also a profile picture and a short descriptive text of the user; from here, if the user wants to make changes to their profile, they can reach their edit profile view (see eg. FIG. 27).

1.10 Outfitting Recommendation

Associated with the ‘Wanda’ user interface, we introduce an outfitting recommendation mechanism, which provides the user with a list of garments which are recommended to combine with the garment(s) the user's virtual avatar is wearing.
Building an outfit relation map from render logs

We explore the historical data warehouse (e.g. the render logs), which stores a list of records containing pairwise information of: 1) the user identifier u, which can be used to look up user attribute data including body measurement parameters, demographic information, etc., and 2) the outfit combination O tried on, which is in the format of a set of garment identifiers {gₐ, g_{b}, g_{c}, . . . }. Examples of outfitting data record are given as follows:
{user: u, outfit: {gₐ, g_{b}}}, {user: u₁, outfit: {gₐ, g_{b}, g_{c}}}, {user: u₂, outfit: {gₐ, g_{d}}}

In the outfitting model, we assume that the user adds one more garment to the current outfit combination on the virtual avatar each time. The recommendation is on an incremental basis and hence it can be approximately modelled by a first-order Markov model. To perform the recommendation, we first try to build an outfit relation map list M for all users who have appeared in the historical data. Each item in M will be in the format of
{{outfit: O, garment: g}, {user: u, frequency: f}}.

The outfit relation map list M is populated from the historical data H with the following Algorithm 1:

1 Initialize M={ }

2 For each record entry (user: u, outfit: O) in the historical data H:

3 For each subset S of the outfit combination O (including φ but excluding O itself):

4 For each garment g in O\S,

5 If an entry with keys {{outfit: S, garment: g}, {user: u, frequency: f}} already exists in M,

6 Update the entry with an incremental frequency f+1:
{{outfit: S, garment: g}, {user: u, frequency: f+1}}

7 Else,

8 Insert a new entry {(outfit: S, garment: g), {user: u, frequency: 1}} to M.
Algorithm 1: The pseudo code to populate user's outfit relation map.

This population process is repeated over all the users in the render history and can be computed offline periodically.
Recommendation:

In the recommendation stage, we assume that a new user u* with the current outfit combination O* is trying to pick up a new garment in the virtual fitting room, where the new garment has appeared in the historical record. Recommendation score R(g′) for an arbitrary new garment g* not in the current outfit O* is computed by aggregating all the frequencies fᵤ of the entries with the same outfit-garment keys (outfit O*, garment g*) in the list M for all existing users u in the historical data D using the following equations.

R(g′)=w_{g}_{^{−}}ₜΣᵤs(u⁻,u)fᵤ .(1.1)

The time weight w_{g}_{^{−}}ₜ of the garment g* and the user similarity s(u′, u) in the equation (1.1), and ranking approaches are detailed in the following sections,
Weighting with user similarity.

Given each user u who has appeared in the outfitting history, we weight the frequency of a user u's outfitting record based on the similarity of the current user u* and u. The similarity of two users u and u′ is defined as follows:

s(u,u′)=1/(1+d(b(u),b(u′))), (1.2)

where b(u) is a feature vector of user u (i.e. body metrics or measurements such as height, weight, bust, waist, hips, inside leg length, age, etc), and d (.,.) is a distance metric (e.g. Euclidean distance of two measurements vectors). We then accumulate the weights of all similar body shapes for recommendation.
Time weighting

For online fashion, it is preferable to recommend more recently available garment items. To achieve that, we could also weight the each garment candidate with its age t on the website by

w_{g*,t}=exp(−t_{g*}/T), (1.3)

where t_{g*} is the existing time of garment g*, and T is a constant decay window, usually set to 30 to 90 days. This mechanism will slowly expire the older top-ranking garment items and tend to bring more recent garment items into the recommendation list. If we constantly set w_{g*,t}=1, no time weighting will be applied to the recommendation,
Recommending a garment not in the history

We can also generalise the formulation in Eq. (1.1) so that the algorithm can recommend a new garment g* which never appears in the historical record H. In that case, we may make recommendation based on the other garments in the historical record H which are similar to g* as the following equation (1.4) shows:

R(g′)=w_{g}_{^{′}}ₜΣ_{g}sᵤ(g′,g)Σᵤs(u⁻,u)fᵤ ,(1.4)

where s_{g}(g⁻,g) defines a similarity score between the garment g* and an existing garment g in the historical record H. The similarity score s_{g}(g⁻,g) can be computed based on the feature distances (i.e. Euclidean distance, vector correlation, etc.) of garment image features and metadata, which may include but is not limited to colour, pattern, shape of the contour of the garments, garment type, fabric material,
Ranking mechanism

We compute the recommendation score R(g) for every single garment g in the garment database, and then rank the garment to be recommended based on their recommendation scores. Two different ranking approaches can be used for generating the list of recommended garments.

1. Top-n: This is a deterministic ranking approach. It will simply recommend the top n garments with the highest recommendation scores.

2. Weighted-rand-n: It will randomly sample n garment candidates without replacement based on a sampling probability proportional to the recommendation scores R(g). This ranking approach introduces some randomness to the recommendation list.

Section 2: The “Crowd” User Interface

2.1 Overview of the User Interface

The “Crowd” user interface is a user interface in which a collection of virtual avatars are displayed. In an example, a crowd of people is shown to the user. These avatars may differ in any combination of outfits, body shapes, and viewing angles. In an example, these people are all wearing different outfits, have different body shapes and are shown from different angles. The images may be generated using (eg. Metail's) visualisation technology which allows different body shapes to be modelled along with garments on those body shapes. A number of visual effects and recommendation features may be associated with this user interface. The “Crowd” user interface may contain the following major example product features:
A crowd of virtual avatars is shown to the user. The images may be generated using a visualisation engine which allows different avatars to be modelled along with garments on a range of body shapes.
Virtual avatars are distributed in multiple rows (typically three, or up to three), one behind the other. Within each row the virtual avatars may be evenly spaced. The size of the model is such that there is perspective to the image with virtual avatars arranged in a crowd view.
The layout of the crowd may have variety in what garments are shown and on what model and body shape are shown—this sequence may be random, pre determined manually, the result of a search by the user, created by another user or determined by an algorithm, for example.
Randomly variant clothed avatars may be randomly generated, manually defined, the result of a search by the user, created by another user, or determined by an algorithm, for example.
A seamless “infinite” experience may be given by repeating the sequence if the user scrolls to the end of the set of models.
The user interface may be provided in profile or in landscape aspects.

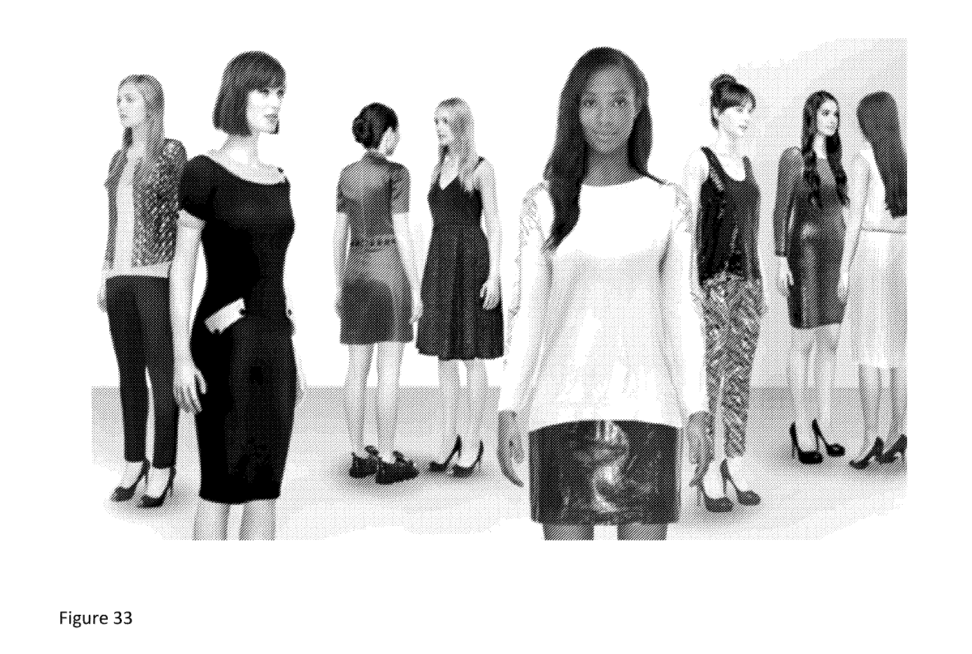

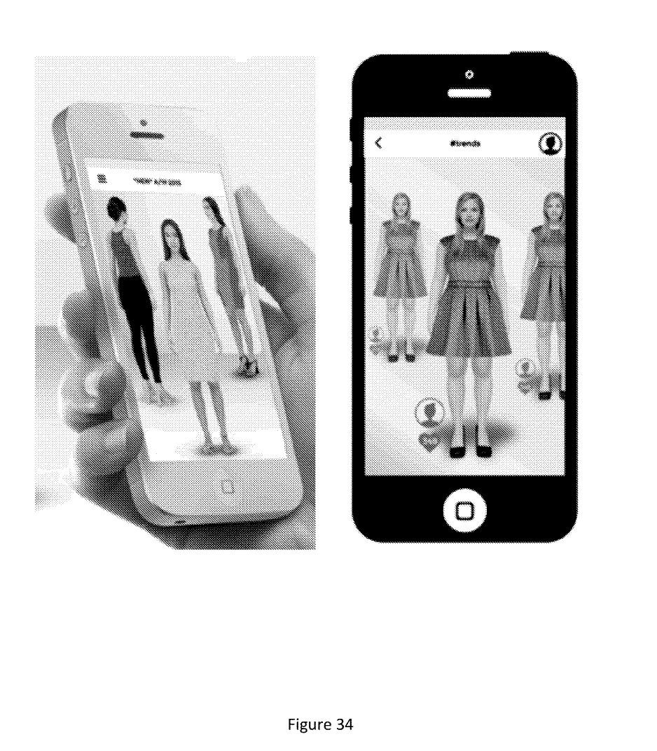

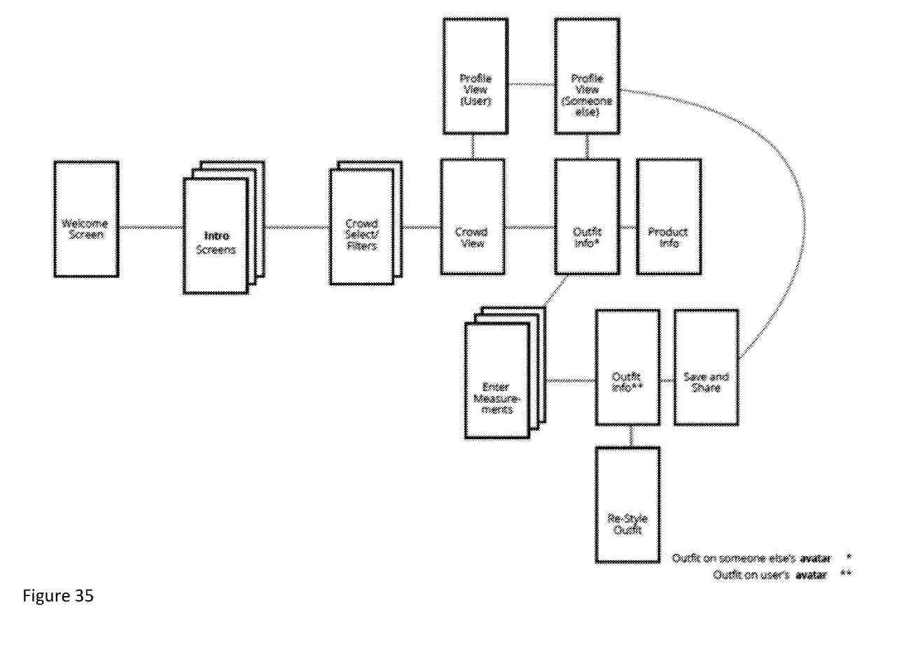

Please refer to FIG. 33 for a concrete example of the user interface (UI) layout. This user interface may be implemented and ported to a mobile platform (see FIG. 34 for examples). FIG. 35 defines a typical example user flow of a virtual fitting product built on the “Crowd” user interface.

2.2 Effects with Respect to the “Crowd” User Interface and Mathematical Models
Horizontal sliding effects:

The user can explore the crowd by sliding their finger horizontally over the screen. With this operation, all the body models in the screen move with predefined velocities to generate the effect of a translational camera view displacement in a perspective scene. In the process, the camera eye position e and target position t are translated horizontally with the same amount from their original positions e₀ and t₀ respectively, while the camera direction remains unchanged.

e=e₀+(Δx,0,0)

t=t₀+(Δx,0,0) (2.1)

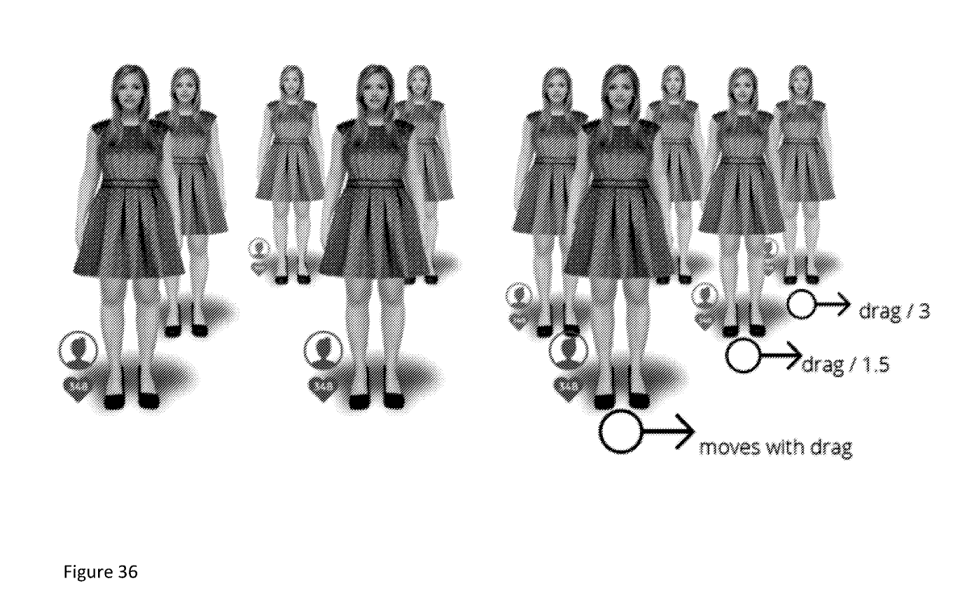

According to the principle of projective geometry, we can use the following formulations to model the constraints among the scale s of the virtual avatars, the sliding speed v of the body models, and the image ground height h of each layer i (i=0, 1, 2, . . . , L) under this camera transform. Assuming zᵢ is the depth of virtual avatars in layer i (away from the camera centre), then the sliding speed vᵢ, the scaling factor sᵢ, and the image ground height hᵢ (i=0, 1, 2, . . . , L) are given by:

$$\frac{{z}_{0}}{{z}_{i}} = \frac{{s}_{i}}{{s}_{0}} = \frac{{v}_{i}}{{v}_{0}} = \frac{{h}_{horizon} - {h}_{i}}{{h}_{horizon} - {h}_{0}} , \qquad ( 2.2 )$$

where z₀, v₀, s₀ and h₀ are the depth, the sliding speed, the scaling factor, and the ground height of the foreground (first) layer 0, respectively. h_{horizon} is the image ground height of the horizon line, which is at the infinite depth. By applying different sliding speeds vᵢ to different depth layers i (i=0, 1, 2, . . . , L) in the scene according to equations (2.2), we can achieve a perspective dynamic layering effect. A simple mock implementation example is illustrated in FIG. 36. When a user swipes, and their finger lifts off the touchscreen the all layers should gradually halt.
Viewpoint change effects

When the user tilts the mobile device left or right, we can mimick the effect of a weak view rotation targeted at the foreground body model. In this process, the camera eye position e is translated horizontally from their original positions e₀, while the camera target position t remains unchanged, as the following equation (2.3) shows:

e=e₀+(Δx,0,0)

t=t₀ (2.3)

Under a weak perspective assumption where the translation Δx is small and the vanishing points are close to infinite, we can use the following equation (2.4) to approximately model the horizontal translation Δxᵢ of each background layer i (i=1, 2, . . . , L) under this camera transform and achieve a view change effect:

$$Δ {x}_{i} = - \frac{{z}_{i} - {z}_{0}}{{z}_{i}} Δ x , \qquad ( 2.4 )$$

where z₀ and zᵢ is the depth of the foreground (first) layer and each background layer i (i=1, 2, . . . , L), respectively. In an implementation, the amount of the eye translation Δx is proportional to the output of the accelerometer in the mobile device, integrated twice with respect to time.
Vertical sliding effects:

When the user slides their finger vertically over the screen, we could activate the following “Elevator effects” and/or the “Layer-swapping effects” in the “Crowd” user interface products:

1. Elevator effects

When the user slides their finger over the screen vertically, an elevator effect will be created to switch to the next floor (either upstairs or downstairs). Also, an effect of looking-up/looking-down under a small rotation will be mocked up during the process.

In each floor, garments and/or outfits of a trend or a brand can be displayed eg. as a recommendation feature.

Elevator effects may be generated based on the following formulations of homography transform. Let K be the 3×3 intrinsic camera matrix for rendering the body model, and R be the 3×3 extrinsic camera rotation matrix. The homography transform makes the assumption that the target object (the body model in our case) is approximately planar. The assumption is valid when the rotation is small. For an arbitrary point p in the original body model image which is represented in a 4d homogeneous coordinate, its corresponding homogeneous coordinate p′ in the weak-perspective transform image can thus be computed as:

p′=Hp=KR⁻¹K⁻¹p. (2.5)

2. Layer Swapping Effects

We can also implement layer swapping effects with a vertical sliding. After the sliding, the virtual avatars in the background now come to the foreground, while the foreground ones now move to the background instead. There may be an animated transition for the layer swapping.
Translucency modeling of layers

We apply the fog model, i.e. a mathematical model with respect to the translucency (alpha value) and the depth of the virtual avatars, to model the translucency of different depth layers. Assume the cⱼ is the colour of the fog (eg. in RGBA) and c_{b} is the sample colour from the texture of the body model. After the processing, the processed sample colour c is computed as

c=fc_{f}+(1−f)c_{b} ,(2.6)

where f is the fog compositing coefficient that is between 0 and 1. For the linear-distance fog model, f is determined by the distance of the object (i.e. the virtual avatar) z as

$$f = \frac{z - {z}_{near}}{{z}_{far} - {z}_{near}} , \qquad ( 2.7 )$$

We select zₙₑₐᵣ to be the depth z₀ of the first layer so no additional translucency will be applied to the foremost body models.
“Walking into the Crowd” effect:

The effect can be achieved by applying transformations for scale and translucency transition. The transition of virtual avatars can be computed using the combinations of the equation (2.2) for layer movement and equations (2.6), (2.7) for creating the fog model.
Rotational body model switching effect:

This effect animates the dynamic process of switching a nearby body model from the background to the foreground using an elliptical rotational motion. Mathematically, the centroid position p=(x,y) of the body model may follow an elliptical trajectory during the transformation. The transformation of the scale s and translucency colour c of the model may be in synchronisation with the sinusoidal pattern of the model centroid displacement. In combination with equations (2.1) and (2.3), the parametric equations for computing the model central position p=(x,y), the scale s, and the translucency colour c during the transformation may be as follows:

x=x_{end}−(x_{end}−xₛₜₐᵣₜ)cos(πt/2),

y=yₛₜₐᵣₜ+(y_{end}−yₛₜₐᵣₜ)sin(πt/2),

s=sₛₜₐᵣₜ+(s_{end}−sₛₜₐᵣₜ)sin(πt/2),

c=cₛₜₐᵣₜ+(c_{end}−cₛₜₐᵣₜ)sin(πt/2), (2.8)

where t is between 0 and 1, and t=0 corresponds to the starting point of the transformation and t=1 corresponds to the ending point of the transformation.
Background synthesis

The floor and the background can be plain or an image that makes it look like the crowd is in a particular location. The background and the floor can be chosen by the user or customized to match some garment collections, e.g. using a beach image as the background when visualising the summer collection in the “Crowd”. Intermediate depth layers featuring images of other objects may also be added. This includes but is not restricted to garments, pillars, snow, rain, etc.

We can also model a lighting variation on the background: e.g. a slow transition from bright in the centre of crowd to dark at the periphery of the crowd. As a mathematical model, the intensity of the light source I may be inversely correlated with the Euclidean distance between the current location p to the centre of the “Crowd” c (in the camera coordinate system) as the example of equation (2.9) shows:

I=Iₘₐₓ/(1+γ∥p−c∥²), (2.9)

where γ is a weighting factor that adjusts the attenuation of the light.
Other additional user interaction and social network features

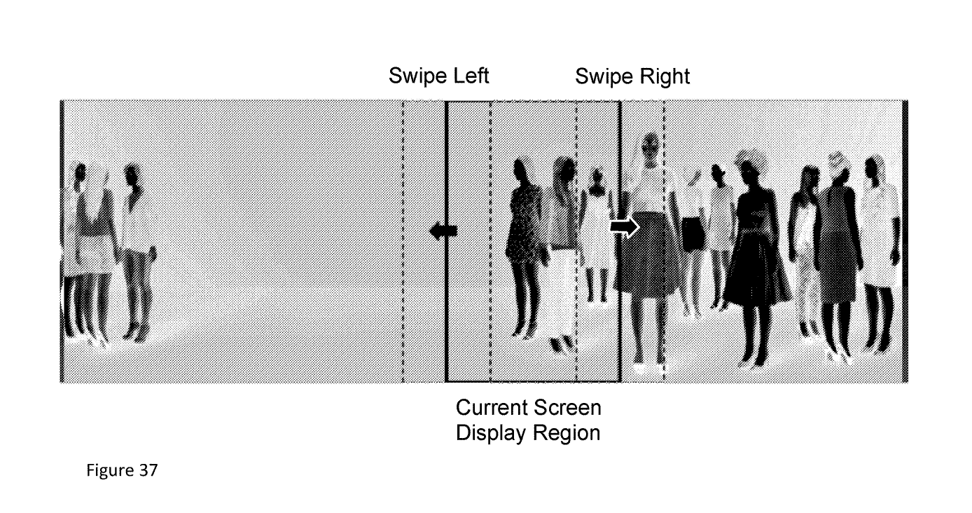

The user can interact with the crowd to navigate through it. Some examples of such interaction are:
Swiping left or right moves the crowd horizontally so that more avatars can be revealed from a long-scrolling scene. The crowd may eventually loop round to the start to give an ‘infinite’ experience. These features can be particularly useful for a mobile-platform user interface (see FIG. 37 for example). As a guideline of layout design when the user scrolls through the crowd, the spacing of the body avatars may be such that the following constraints apply:
No more than 3.5 avatars appear on the phone screen;
Avatars in the same screen space are not to be in the same view.
Swiping up or down moves to another crowd view that is brought in from above or below.
Clicking on a model allows the user to see details of that outfit including, but not limited to, being able to try that outfit on a model that corresponds with their own body shape.

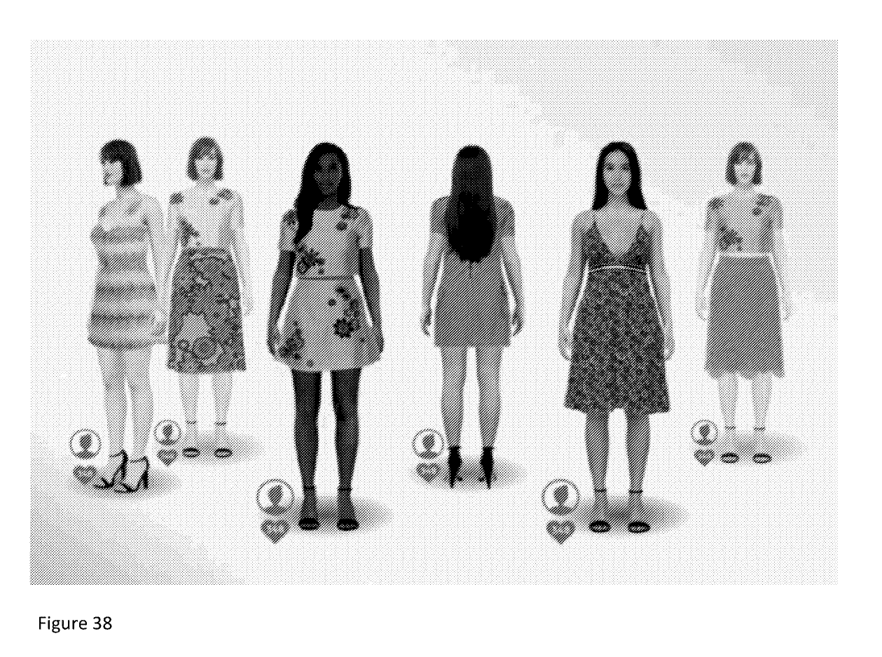

Clicking on icons by each model in the crowd brings up other features including, but not limited to, sharing with others, liking on social media, saving for later, and rating (see FIG. 38 for an example).

2.3 Recommendation Mechanisms

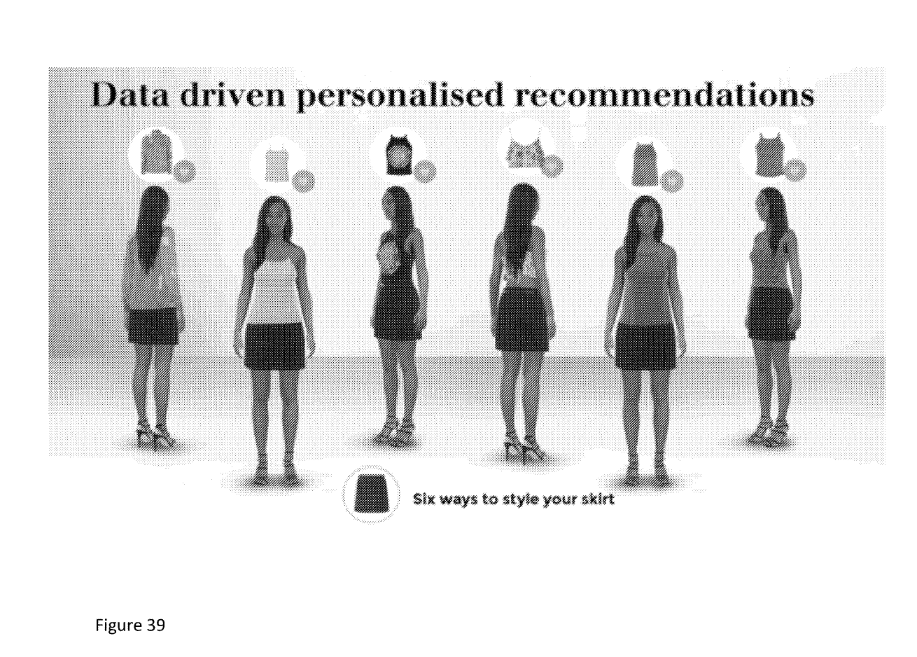

We can arrange the garments and the outfits of those neighbouring background body models in the “Crowd” by some form of ranking recommendation mechanism (see FIG. 39 for an example of “Crowd” user interface with recommendation features). For instance, we may dress the nearby models and re-order them by the following criteria:
Garments that are most liked;
Garments that are newest;
Garments of the same type/category/style/trend as the current garment;
Garments that have the user's preferred size available;
Garments of the same brand/retailer as the current garment;
User's browsing history: e.g. For the body models from near to far, sorted from the most recently visited garment to the least recently visited one.

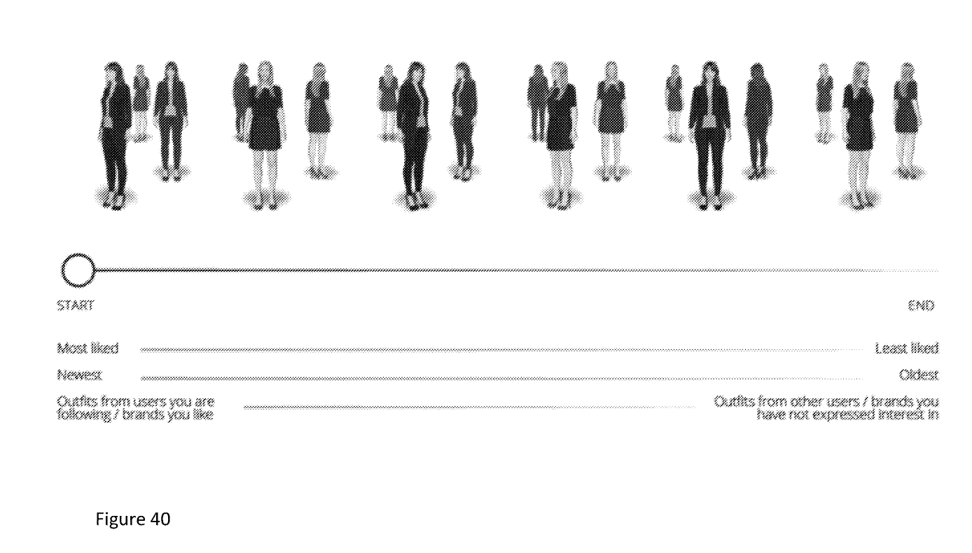

Examples of ranking mechanisms when placing avatars in the crowd are illustrated in FIG. 40.

Several further recommendation algorithms may be provided based on the placements of body models in the “Crowd” user interface, as described below.
Ranked recommendations based on the attributes of users

We can recommend a user those outfits which are published on the social network by her friends or those outfits selected by other virtual fitting room users who are in similar body shapes to her.

The ranking model may then be based on mathematical definitions of user similarity metric. Let b be the concise feature representation (a vector) of a user. For example b can be a vector of body metrics (height and weight) and tape measurements (bust, waist, hips, etc.), and/or other demographic and social network attributes. The similarity metric m between two users can be defined as the Mahalanobis distance of their body measurements bₐ and b_{b}:

m(bₐ,b_{b})=(bₐ−b_{b})^{T}M(bₐ−b_{b}), (2.10)

where M is a weighting matrix accounting for the weights and the correlation among different dimensions of measurement input. The smaller the m, the more similar the two users. The recommended outfits are then ranked by m in an ascending order.
Ranked recommendations based on attributes of garments and/or outfit (aka. fashion trend recommendation)

We can recommend popular outfit combinations containing one or more garments that are identical or very similar to a subset of the garments in the current outfit selected by the user. We may then rank the distances or the depths of the body models by a measurement of the popularity and the similarity between the two outfit combinations.

Mathematically this can be achieved by defining feature representations of the outfit and the similarity metrics, and applying a collaborative filtering. To formulate the problem, we represent a garment by a feature vector g, which may contain information including, but not limited to, garment type, contour, pattern, colour, and other types of features.

The outfit combination may be defined as a set of garments (feature vectors): O={g₁, g₂, . . . g_{N}}. The dissimilarity metric d(Oₐ, O_{b}) of two outfit combinations Oₐ and O_{b} may be defined as the symmetric Chamfer distance:

$$d ( {O}_{a} , {O}_{b} ) = \frac{1}{Na} \text{?} {min}_{i} {‖ {g}_{a , i} - {g}_{b , i} ‖}^{2} + \frac{1}{Nb} \text{?} {min}_{i} {‖ {g}_{a , i} - {g}_{b , i} ‖}^{2} . \\ \text{?} \text{indicates text missing or illegible when filed} \qquad ( 2.11 )$$

The weighted ranking metric mᵢ for outfit ranking is then defined based on the product of the dissimilarity between the current outfit O′ user selected and each existing outfit Oᵢ published on the social network or stored in the database, and the popularity pᵢ of the outfit Oᵢ, which could be related to the click rate cᵢ for example, as the following equation (2.12) shows:

mᵢ=pᵢd(O′,Oᵢ)=log(cᵢ+1)d(O′,Oᵢ) (2.12)

To recommend an outfit to a user, we may rank the all the existing outfits )Oᵢ)ᵢ₌₁^{X} according to their corresponding weighted ranking metrics (mᵢ)ᵢ₌₁^{M} in an ascending order, and dress them onto the body models in the “Crowd” from the near to the far.
Ranked recommendations based on attributes of both users and garment/outfit combinations.

We may define a combined ranking metric m which also takes user similarity into account. This may be done by modifying the definition of the popularity pᵢ of the outfit Oᵢ, which is used in the following equation (2.13):

$${p}_{i} = log ( 1 + \text{?} \frac{1}{1 + β \text{?}} ) , \\ \text{?} \text{indicates text missing or illegible when filed} \qquad ( 2.13 )$$

where β is a hyper-parameters adjusting the influence of user similarity, b is the user feature of the current user, and bᵢⱼ is the user feature of the each Metail user profile j that has tried on the outfit Oᵢ. The ranking and recommendation rules will still follow the equation (2.13).

2.4 Other Product Features

Other product features derived from this “Crowd” design may include:
A user can build up their own crowd and use it to store a wardrobe of preferred outfits.
Crowds may be built from models that other users have made and shared.
The user can click on an outfit and then see that outfit on her own virtual avatar. The outfit can then be adjusted and re-shared back to the same or a different crowd view.
We can replace some of the garments in an outfit and display these new outfits in the “Crowd”.
We can use the “Crowd” user interface to display the results from an outfit search engine. For example, a user can search by combination of garment types, e.g. top+skirt, and then the search results are displayed in the “Crowd” and ranked by the popularity.
The user can explore other users' interest profiles in the “Crowd”, or build a query set of outfits by jumping from person to person.

User Interaction Features

The user may interact with the crowd to navigate through it. Examples are:
Swiping left or right moves the crowd horizontally so that more models can be seen. The crowd eventually loops round to the start to give an ‘infinite’ experience.
Swiping up or down moves to another crowd view that is brought in from above or below.
Clicking on a model allows the user to see details of that outfit, including but not limited to being able to try that outfit on a model that corresponds with their own body shape.
Clicking on icons by each model in the crowd brings up other features, examples of which are: sharing with others, liking on social media, saving for later, rating.

Section 3: Dynamic Perspective User Interface

3.1 Summary of the User Interface

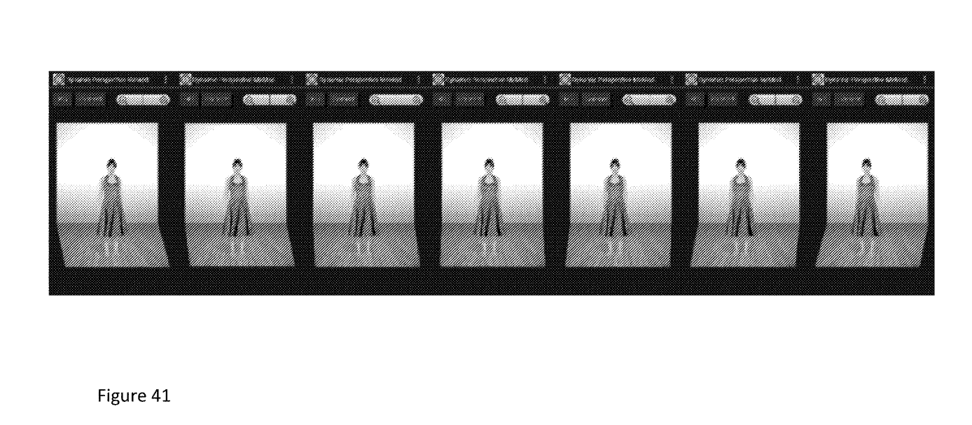

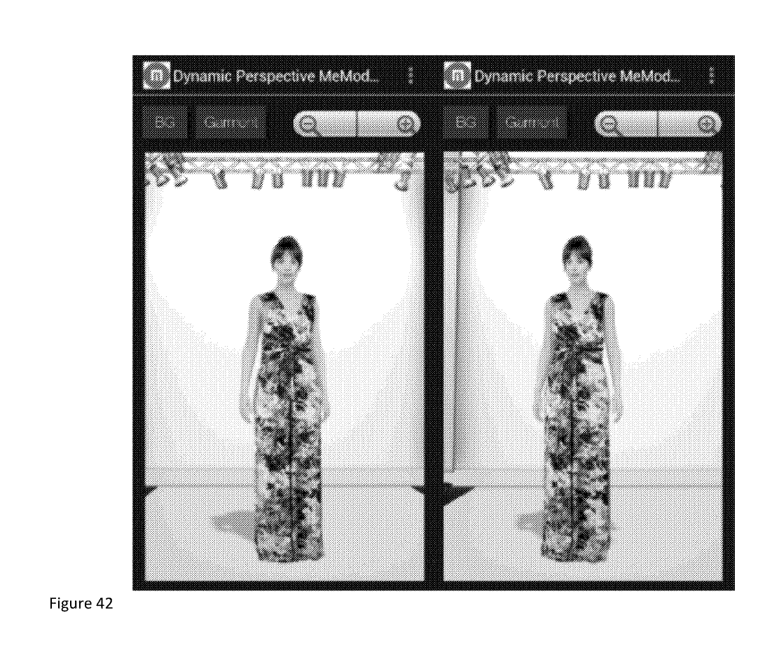

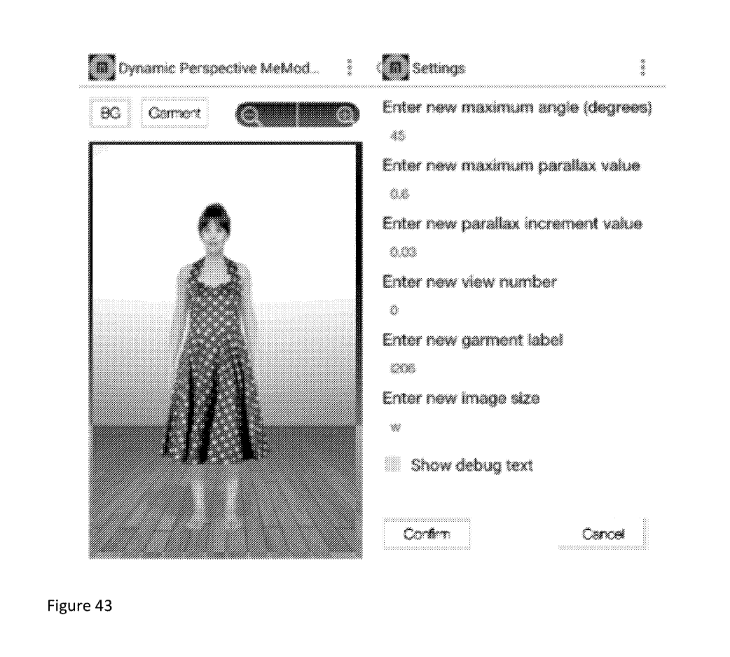

The dynamic perspective user interface generates a user experience wherein one is given the feeling of being able to move around the sides of the virtual avatar by either moving one's head around the mobile device (eg. phone), or simply turning the mobile device (eg. phone) in one's hand, which is detected with a head-tracker module, or which could be identified by processing the output of other sensors like an accelerometer (see FIG. 41 for example). More feature details are summarised as follows:
When a head-tracking module is used, the application may produce a scene that responds to the user's head position such that it appears to create a real 3-dimensional situation.
The scene is set with the midpoint of the virtual avatar's feet as the pivot point, so the user is given the impression of moving around the model to see the different angles.
The scene may consist of three images: the virtual avatar, the distant background, and the floor.
The background images are programmatically converted into a 3D geometry so that the desired 3D scene movement is achieved. This could also be emulated with more traditional graphics engines, but would require further implementation of responsive display movement.
With the user interface, a stereo vision of the virtual avatar in a 3D scene can be created on a 3D display device, by generating a left-eye/right-eye image pairs with the virtual avatar images rendered in two distinct rotational positions (see FIG. 42 for example).
The application or user interface includes a variety of settings to customise sensitivity and scene appearance (see FIG. 43 for example).

3.2 Scene Construction

In the dynamic perspective design, the scene itself consists of three images indicating distinct 3D layers: the virtual avatar, the remote vertical background, and the floor plane. This setting is compatible with the application programming interfaces (APIs) of 3D perspective control libraries available on the mobile platform, which may include but are not limited to e.g. Amazon Euclid package.

As a specific example of implementation, the scene can be constructed using the Amazon Euclid package of Android objects, which allow the specification of a 3D depth such that images and other objects move automatically in response to user head movement. The Euclid 3D scene building does not easily allow for much customisation of the movement response, so the 3D geometry of the objects must be chosen carefully to give the desired behaviour. This behaviour may be emulated with other, simpler screen layouts in 2D with carefully designed movement of the images in response to detected head movement. Within the main application screen, the scene is held within a frame to keep it separate from the buttons and other features. The frame crops the contents so that when zoomed in or rotated significantly, edge portions are not visible.

3.2.1 The Virtual Avatar

Since the desired behaviour of the virtual avatar is for it to rotate about the vertical axis passing through the centre of the model, its motion cannot properly be handled by most of the 3D perspective control libraries on the mobile platform, as these would treat it as a planar body, which is a poor approximation when dealing with areas like the face or arms where significant variation in movement would be expected. This may instead be dealt with by placing the virtual avatar image as a static image at zero depth in the 3D scene and using a sequence of pre-rendered images as hereafter detailed in Section 3.3.

3.2.2 Background

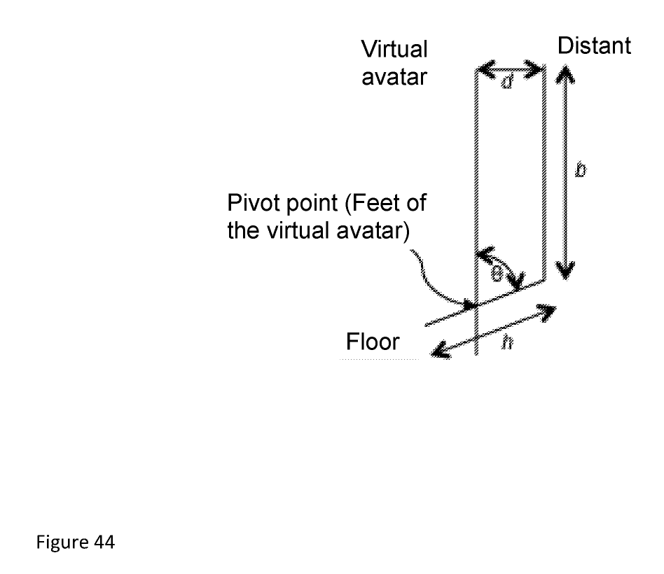

Most built-in 3D perspective control libraries on the mobile platform, e.g. Amazon Euclid, treat all images as planar objects at a given depth and orientation. Observation of the movements produced as the user's head moves indicates that a point is translated at constant depth in response to either vertical or horizontal head movement. This is what makes it ineffective for the virtual avatar, as it does not allow for out-of-plane rotation. To achieve the desired effect of a floor and a remote vertical background (e.g. a wall or the sky at the horizon), the distant part of the background must be placed independently of the floor section, with the distant image placed as a vertical plane, and the floor image oriented such that the top of the image is deeper than the bottom of it (that is, rotated about the x-axis, which is the horizontal screen direction). Mathematically, it may be set up such that:

$$θ = {tan}^{- 1} \frac{d}{v ( b \vert h ) - b} , \qquad ( 3.1 )$$

where v=vertical coordinate of the pivot point, as a fraction of the total image height (set to correspond to the position of the feet of the virtual avatar, measured from the top of the image; analysis of a virtual avatar image indicates the value should be around 0.9); other variables may be defined as shown in FIG. 44.

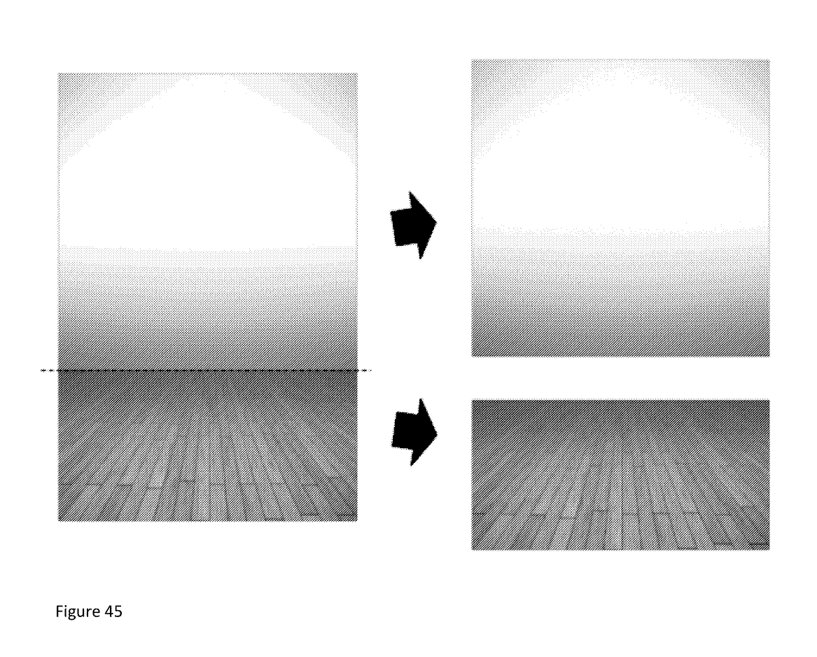

The values of h and b are retrieved automatically as the pixel heights of the separated remote background and floor images, which are created by dividing a background image at a manually determined horizon line, as illustrated in FIG. 45 by way of example. The depth value for each background image may be set and stored in the metadata for the image resource. It may correspond to the real-world distance to the distant section of the background e.g. as expressed in the scale of the image pixels.

3.3 Modelling the Rotation of the Virtual Avatar

The avatar is shown to rotate by use of a progressive sequence of images depicting the model at different angles. For details about the methods which may be used to generate these parallax images of the virtual avatars from 3D models and 2D models, see Section 3.4.

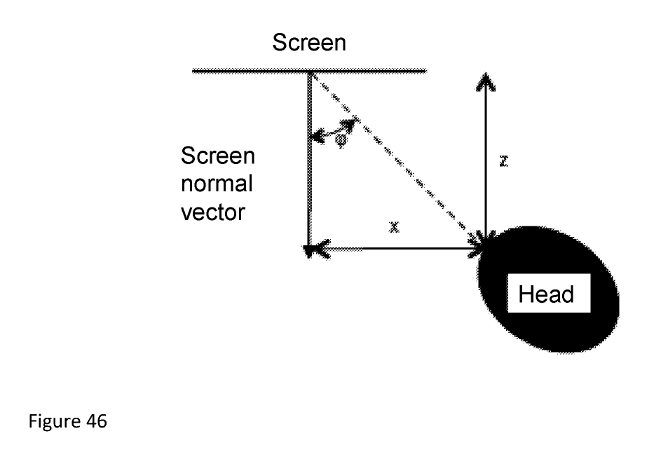

Given that the parallax images are indexed with a file suffix indicating the rotation angle depicted, the desired image may be selected using the following formula for the stored image angle p:

$$p = s \text{?} ⌊ \frac{{p}_{max} \times min ( φ / {φ}_{max} , 1 )}{r} ⌋ \text{?} r , \\ \text{?} \text{indicates text missing or illegible when filed} \qquad ( 3.2 )$$

where:
φ=|tan⁻¹x/z| is the head rotation angle (with x, relative horizontal face position, and z, perpendicular distance to the face from the screen, as shown in FIG. 46, retrieved from the face-tracking module), or which could be an angle given as output from an accelerometer, integrated twice with respect to time, or similar,

$$s = - sgn ( x ) = \{ \begin{matrix}+ 1 , x < 0 \\ - 1 , x > 0\end{matrix}$$

is the sign to match the direction of rotation in the stored images,
φₘₐₓ is the viewing angle at which maximum rotation is required to occur (also see Section 3.5.1),
pₘₐₓ is the maximum rotation angle desired (i.e. extent to which the image should rotate); this is not an actual angle measurement, but rather a value (typically between 0 and 1) passed to the internal parallax generator,
p is desired increments of p to be used (this sets the coarseness of the rotation and is also important to reduce lag as it dictates how often a new image needs to be loaded as the head moves around),
   | | in Eq. (3.2) means that the largest integer less than the contents is taken, resulting in the largest allowable integer multiple of r being used.

Taking this value, together with a garment identifier, view number, and image size, an image key is built and the correct image collected from the available resources using said key, for example as described in section 3.5.2.

3.3.1 Generating Stereo Image Pair for 3D Display

Based on Eq. (3.2), we can render a pair of parallax images (p, −p) with the same parallax amount p but of the opposite directions of rotation. This pair of images can be fed into the left-eye channel and the right-eye channel of a 3D display device respectively for the purpose of stereo visualisation. The possible 3D display device includes but is not limited to e.g. Google cardboard, or a display device based on polarised light. An example of a parallax image pair is given in FIG. 42.

3.4 Generating Texture Images for the Rotated Virtual Avatar

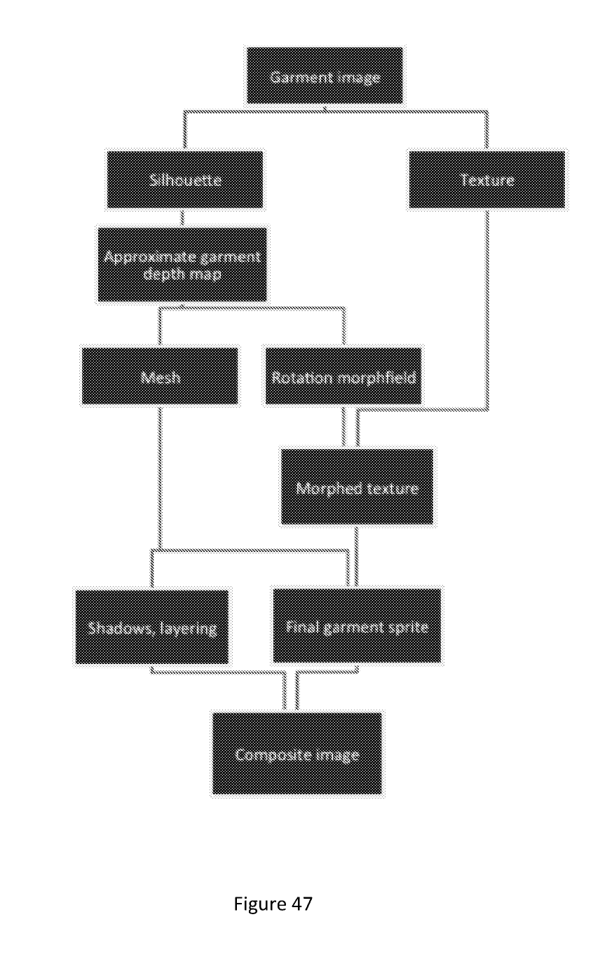

An example of an end to end process of rendering 2D texture images of an arbitrarily rotated virtual avatar (see Section 3.3) is summarised in FIG. 47. In general, different rendering solutions are applied dependent on whether 3D geometries of the components of the virtual avatar are available or not. These components include the body shape model, the garment model (s) in an outfit, and the head model, etc.
Case 1: The 3D geometries of all virtual-avatar components are available.

When 3D textured geometry of the whole virtual avatar and 3D garment models dressed on the avatar are all present, generating a render with a rotated virtual avatar can be implemented by applying a camera view rotation of angle φ along the y-axis (the up axis) during the rendering process. The render is straightforwardly in a standard graphics rendering pipeline.
Case 2: Some 3D geometries of the virtual-avatar component are not available.

Some components of the virtual avatar may not have underlying 3D geometries. E.g. we may use 2D garment models for outfitting, in which only single 2D texture cut-out of the garment are present in specific viewpoint). Generating a rotated version of 2D garment models requires first approximating the 3D geometry of the 2D garment model based on some root assumptions, a depth calculation (see Section 3.4.1 for details), and finally a corresponding 2D texture movement will be applied to the image in order to emulate a 3D rotation (see Section 3.4.2 for details).

3.4.1. Generate 3D Approximate Garment Geometry from a 2D Texture Cut-Out

During the process of garment digitisation, each garment is photographed in 8 camera views: front, front right, right, back right, back, back left, left, and front left. The neighbouring camera views are approximately spaced by 45 degrees. The input 2D garment images are hence in one of the 8 camera views above. From these images, 2D garment silhouettes can be extracted using interactive tools (e.g. Photoshop, Gimp), or existing automatic image segmentation algorithms (e.g. an algorithm based on graph-cut).

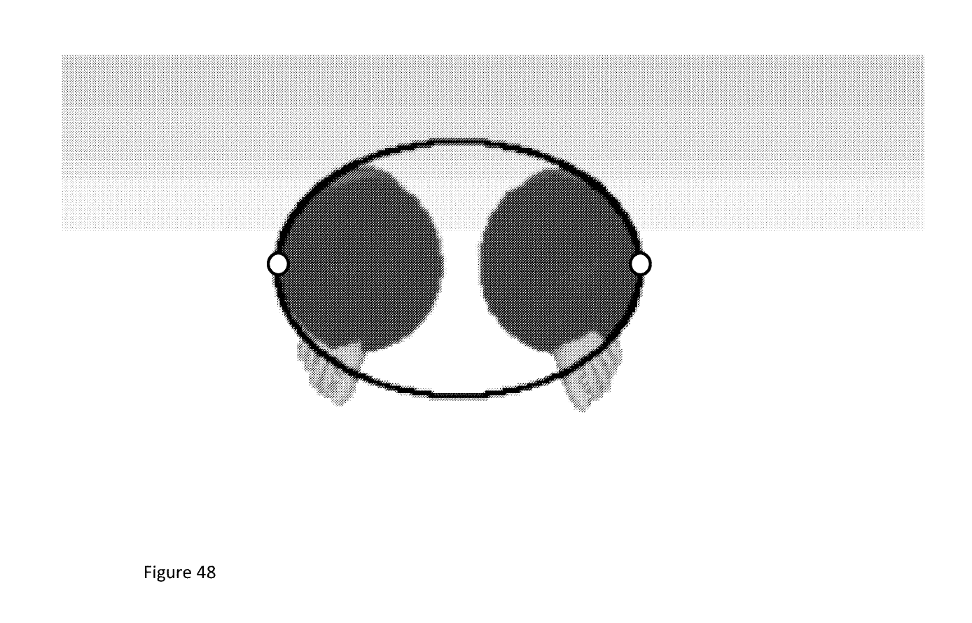

For a 2D torso-based garment model (e.g. sleeveless dresses, sleeves top, or skirts) with a single 2D texture cut-out or silhouette, the 3D geometry model of the garment is approximated by applying the following simplifications:
Around the upper body, the garment closely follows the geometry of the underlying body shape;
Around the lower body, the garment approximates to an elliptic cylinder with varying axis lengths, centred at the origin of the body. At a given height, the ellipse is defined as having the minor axis in the body's forward direction (i.e. the direction the face is pointing), the major axis spanning from the left-hand extremum in the garment texture silhouette to the right-hand extremum, and pre-defined aspect ratio α, (testing indicates that a value of α=0.5 gives desirable results), as depicted at a sample height around the upper legs in FIG. 48. The body origin is given as halfway between the two horizontal extrema of the body silhouette at any given height (e.g. the two white dots in FIG. 48), at a depth corresponding to the arithmetic mean of the depths on the silhouette edge, sampled in a region around the torso.

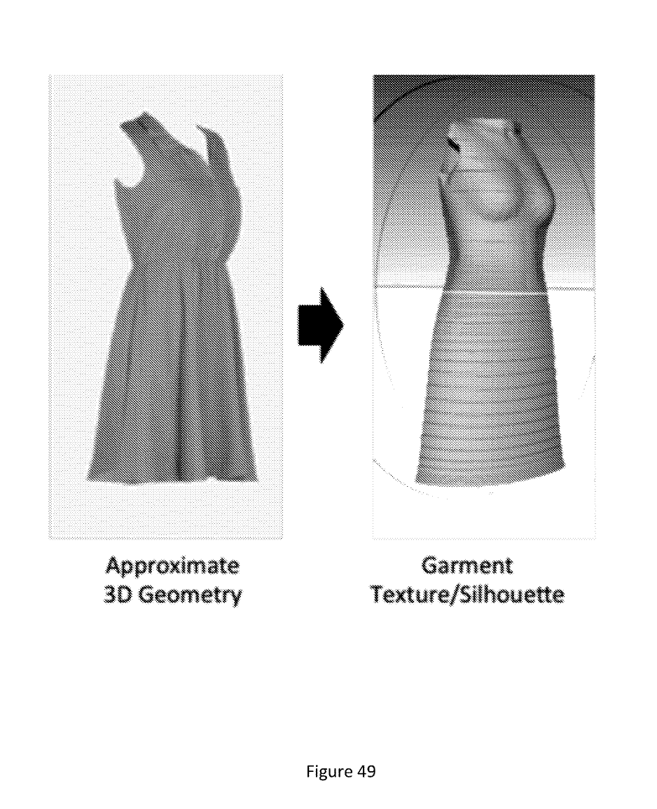

An example of 3D geometry of a dress created from a single 2D texture cut-out using the method described above is given in FIG. 49.

In the implementation, we generate this 3D geometry for each row of the garment image from the top, which corresponds to a given height on the body. In each row, the left and right extrema x_{left} and x_{right} are estimated from the silhouette. For each of the 8 camera views in the digitisation, the semi-major axis length s for the garment ellipse is then given by:

$$s = \{ \begin{matrix}\frac{{x}_{right} - {x}_{left}}{2} , & in the front and back views \\ \frac{{x}_{right} - {x}_{left}}{2 a} , & in the left and right views \\ \frac{\sqrt{2} ( {x}_{right} - {x}_{left} )}{2} , & in the other four corner views\end{matrix} \qquad ( 3.3 )$$

The depth of the ellipse dₑₗₗᵢₚₛₑ (i.e. the perpendicular distance from the camera) at each

pixel in the row is then approximated as the ellipse y-coordinate, yₑₗₗᵢₚₛₑ, subtracted from the body origin depth, y_{body}:

dₑₗₗᵢₚₛₑ=y_{body}−yₑₗₗᵢₚₛₑ ,(3.4)

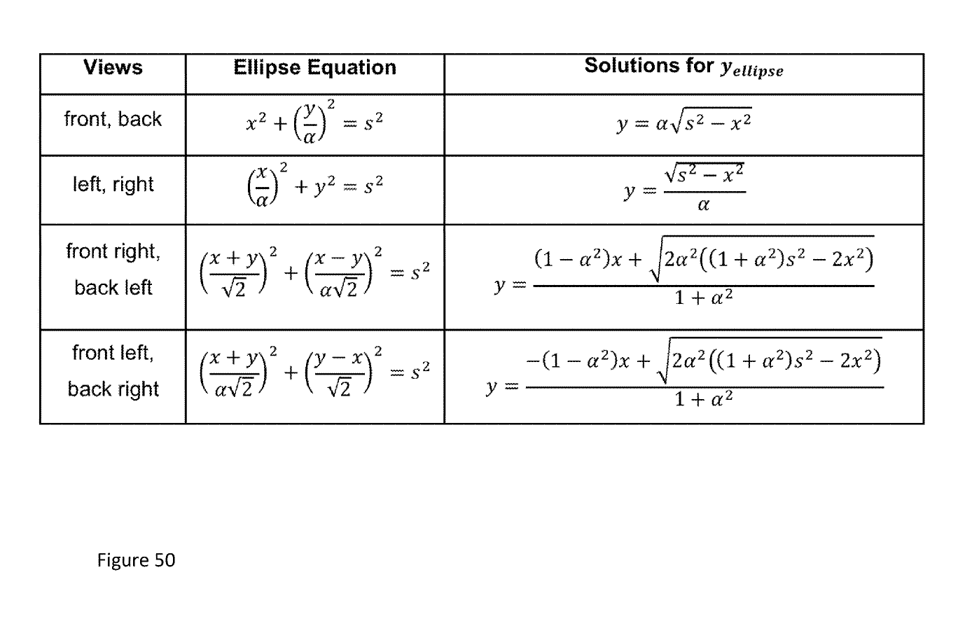

as yₑₗₗᵢₚₛₑ>0 for most x and the garment is closer than the body (See FIG. 50 for example ellipse equations to evaluate yₑₗₗᵢₚₛₑ in different camera views). The final garment depth is approximated as a weighted average of dₑₗₗᵢₚₛₑ and the body depth d_{body} at that point, with weighting w given by:

$$w = \frac{1}{1 + exp ( - ( j - t ) / b )} , \qquad ( 3.5 )$$

where b is the smoothing factor, the extent to which the transition is gradual or severe, j is the current image row index (0 at top), t is the predefined threshold indicating how far up the body the ellipse should begin taking effect, usually defined by the waist height of the body model.

The final depth used to generate the mesh for the approximate geometry is ensured to be lower than that of the body by at least a constant margin d_{margin}, thus given as:

d=min(d_{body}−d_{margin},d_{body}(1−w)+dₑₗₗᵢₚₛₑw). (3.6)

The above approach can be generalised to model complex garment models, e.g. sleeved tops and trousers. In those cases, we may generate the approximate geometry for each part of the garment individually based on the corresponding garment layers and body parts using the equations (3.4)-(3.6) and the example equations shown in FIG. 50. The garment layer and body part correspondence is given as follows.
garment torso part/skirt-body torso;
left (right) sleeve-left (right) arm;
left (right) trouser leg-left (right) leg.

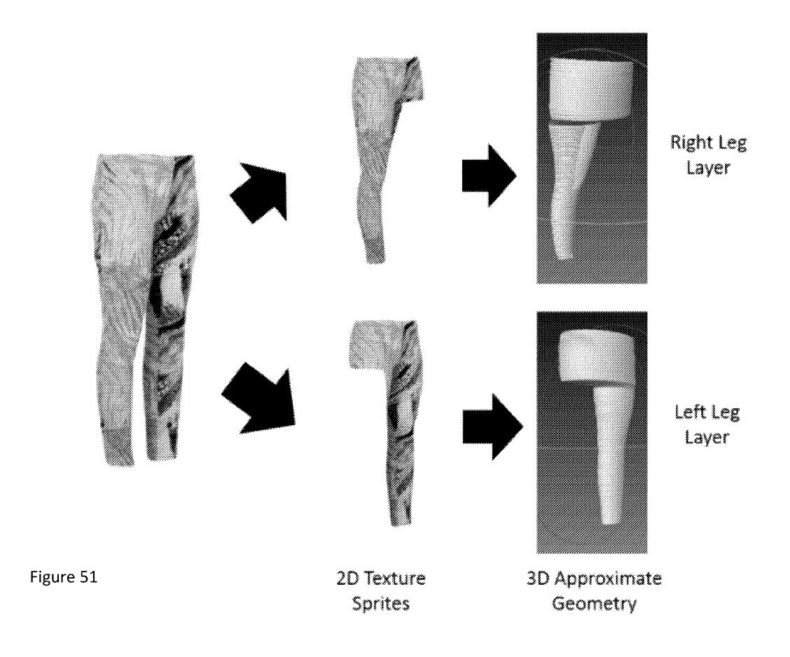

An example of generating 3D approximate geometry of multiple layers for a pair of trousers is given in FIG. 51.

Based on the reconstructed approximated 3D geometry we can then model the 3D rotation of a garment by a 2D texture morph solution as described in Section 3.4.2.

3.4.2 Morph a 2D Texture Based on the Approximated 3D Geometry

Having generated a smooth 3D mesh with faces from the point cloud of vertices given by the depth approximations at each pixel in the previous step, a final normalised depth map of the garment may be generated for the required view. This depth map may be used to calculate the extent to which a given point on the garment texture needs to move in the image in order to simulate an out-of-plane rotation about the vertical axis (the y-axis in screen coordinates). The current normalised position p of a texture pixel is set to:

p=(pₓ,p_{y},p_{z},1), (3.7)

where:
pₓ=

1−j/(w/2), j is the horizontal pixel position, w is the mage pixel width.

p_{y}=

1−i/(h/2), i is the vertical pixel position, h is the image pixel height;

pₓ is the normalised depth from the depth map; resultant values are in range [−1, +1].

Using the viewing camera 4×4 projection, view, and world transformation matrices, P, V, and W respectively, where the multiplied combination WVP represents the post-multiplication transformation from the world coordinates to the image coordinates; a rotation matrix, R, is computed for rotation about the z-axis based on the required angle. The new image coordinate position p′ of the corresponding point on the 3D geometry is then given by:

p′=p^{p-1}V⁻¹W⁻¹RWVP. (3.8)

The resultant 2D transformation on the image, normalised by the full image dimensions, is given by:

$$( \frac{{p}_{x}^{′} - {p}_{x}}{2} , \frac{{p}_{y}^{′} - {p}_{y}}{2} ) . \qquad ( 3.9 )$$

These 2D transformations are stored for a sampled frequency of pixels across the entire image, creating a 2D texture morph field that maps these normalised movements to the pixels.

The 2D texture morph field only has accurately calculated transformations for the region inside the garment silhouette and so must be extrapolated to give smooth behaviour across the entire image. The extrapolation and alteration of the morph to give this smoothness can be carried out in a number of distinct steps as follows:

1. Limit the morph such that any texture areas that are meant to become overlapping are instead forced to collapse to a single vertical line. Owing to internal interpolation between sample points, this is imperfect, but helps to avoid self-intersection of the texture.

2. Extrapolate the morph horizontally from the garment silhouette edges, using a weighted average of the morph values close to the edge to ensure the value does not jump significantly in these areas.

3. Extrapolate the morph vertically from the now-complete rows, simply copying the top and bottom rows upwards and downwards to the top and bottom of the image.

4. Apply a distributed blur smoothing to the morph, e.g. by using a 5×5 kernel in expression (3.10):

$$[ \begin{matrix}1 & 1 & 1 & 1 & 1 \\ 1 & 1 & 2 & 1 & 1 \\ 1 & 2 & 3 & 2 & 1 \\ 1 & 1 & 2 & 1 & 1 \\ 1 & 1 & 1 & 1 & 1\end{matrix} ] . \qquad ( 3.10 )$$

The resultant images produced are the likes of those shown in for example in FIG. 41 and in FIG. 42.

For a more complex garment like trousers or sleeved-top, the above texture morph solution will be applied for each individual garment layer (i.e. torso, left/right sleeve, leg/right leg) individually.

To implement the dynamic perspective visualization systems, two different approaches may be applied:

1) The visualization server generates and transmits the full dynamic perspective images of the garments, given a query parallax angle from the client. This involves computing 2D texture morph fields based on the method described above, and then applying the 2D texture morph fields onto the original 2D garment images to generate the dynamic perspective images.

2) The visualization server only computes and transmits image manipulation functions to the client side. As concrete examples, the image manipulation function can be the 2D texture morph fields (of all garment layers) above, or the parameters to reproduce the morph fields. Then, the client will finish generating the dynamic perspective images from the original 2D garment images locally based on returned image manipulation functions. Since the image manipulation functions are usually much more compact than the full images, this design can be more efficient and give better user experience when the bandwidth is low and/or the images are of a high resolution.

3.4.3 3D approximate geometry and texture morph for the 2D head sprites or 2D hairstyle

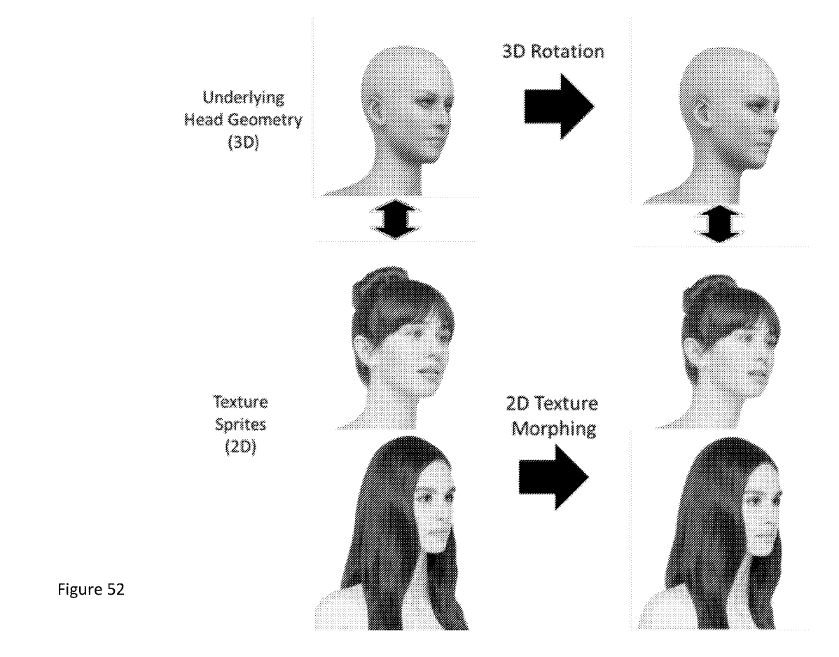

We can use a similar approach to approximately model the 3D rotation of a 2D head sprite or 2D hairstyle image when the explicit 3D geometry is not present. For this, we use the underlying head and neck base geometry of the user's 3D body shape model as the approximate 3D geometry (see FIG. 52 for an example). This allows us to model the 3D rotation of the head sprite/hairstyle from a single 2D texture image using the approach of 2D texture morphing and morph field extrapolation as described in Section 3.4.2 above.

3.5 Other Features and Related Designs

Note that the term “parallax” is used loosely in that it refers only to the principle by which the rotated images are generated (i.e. image sections at different distances from the viewer move by different amounts). In particular, “parallax” angles indicate that the angle in question is related to the rotation of the virtual avatar in the image.

3.5.1 Settings and Customisation

This section gives a sample user interface for setting the parameters of the application. As shown in FIG. 43 by way of example, a number of customisable parameters are available for alteration in-app or in the user interface, which are detailed in the Table below, which shows Settings and customisation available to a user in-app or in the user interface.

| Setting | Effect |
|---|---|
| BG button | Allows user to iterate through available background |
| | images |
| Garment button | Allows user to iterate through available garments for |
| | which images are stored |
| Maximum angle | Sets the maximum viewing angle (α); in range 0-90 |
| Maximum parallax | Sets the maximum virtual avatar image rotation to |
| | be displayed |
| Parallax increment | Sets the increment by which the virtual avatar image |
| | should rotate (indirectly sets the frequency with |
| | which a new image is loaded) |
| View number | Sets the view number to be used for the base image |
| Garment label | Sets a unique garment identifier used to select the |
| | correct image collection |
| Image size | Sets the image size to be used |
| Zoom (+/−buttons, | Zooms in/out on the virtual avatar and background |
| two finger pinch) | section of the main screen |

3.5.2 Image Selection

Given the settings as described in Section 3.5.1, a resource identifier is constructed with which to access the required image resources. The image resources can be indexed by garment setting, view setting, and image size setting.

Whenever settings are initialised or altered, a list of available parallax values for those settings is stored based on the accessible image resources. The list is sorted in increasing values of parallax value from large negative values to large positive values. A nearest index search can be implemented given an input parallax value p. Given an integral equivalent of p (rounded to 2 decimal places, then multiplied by 100), the following ordering of criteria are checked:
If p is less than the first list element (the lowest available parallax), the first element is used;
Otherwise, iterate through the list until a value of parallax is found to be greater than p;
If one is found, check whether p is closer to this larger one or to the previous list element (which must be less than p)—use the closest of these two,
If none is found, use the largest (last element in the list).

This closest available integral equivalent ofp is then used as the final value in the name construction used to access the required image resource.

Notes

In the above, examples are given predominantly for female users. However, the skilled person will understand that these examples may also be applied for male users, with appropriate modifications where necessary.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A method for generating a 3D virtual body model of a person combined with a 3D garment image, and displaying the 3D virtual body model of the person combined with the 3D garment image on a screen of a computing device, the computing device including a sensor system, the method including the steps of:
(a) generating the 3D virtual body model;
(b) generating the 3D garment image for superimposing on the 3D virtual body model;
(c) superimposing the 3D garment image on the 3D virtual body model;
(d) showing on the screen the 3D garment image superimposed on the 3D virtual body model;
(e) detecting a position change using the sensor system, and
(f) showing on the screen the 3D garment image superimposed on the 3D virtual body model, modified in response to the position change detected using the sensor system, wherein the modified 3D garment image superimposed on the 3D virtual body model shown on the screen is modified in perspective.

2. (canceled)

3. The method of claim 1, wherein 3D virtual body model image modification is provided using a sequence of pre-rendered images, or wherein the 3D virtual body model is shown to rotate by use of a progressing sequence of images depicting the 3D virtual body model at different angles.

4. (canceled)

5. The method of claim 1, wherein the position change is a tilting of the screen surface normal vector.

6. The method of claim 1, wherein the sensor system includes an accelerometer, and/or wherein the sensor system includes a gyroscope, and/or wherein the sensor system includes a magnetometer.

7-8. (canceled)

9. The method of claim 5, wherein the a user is given the feeling of being able to move around the sides of the 3D virtual body model by tilting the computing device.

10. The method of claim 1, wherein the sensor system includes a camera or the computing device, or wherein the sensor system includes a pair of stereoscope cameras of the computing device.

11. (canceled)

12. The method of claim 1, wherein the position change is a movement of a head of a user.

13. The method of claim 12, wherein the position change is detected using a head tracker module.

14. The method of claim 12, wherein the user is given the feeling of being able to move around the sides of the 3D virtual body model by moving their head around the computing device.

15. The method of claim 12, wherein the images and other objects on the screen move automatically in response to user head movement.

16. The method of claim 1, wherein the computing device is a mobile computing device, or a mobile phone mobile computing device, or a tablet computer mobile computing device, or a head mounted display mobile computing device.

17. (canceled)

18. The method of claim 16, wherein the mobile computing device asks a user to rotate the mobile computing device, in order to continue.

19. The method of claim 1, wherein the computing device is a desktop computer, or a laptop computer, or a smart TV, or a head mounted display.

20-21. (canceled)

22. The method of claim 1, wherein the screen shows a scene, in which the scene is set with the midpoint of the 3D virtual body model's feet as the pivot point, so the user is given the impression of moving around the model to see the different angles.

23. The method of claim 1, wherein a scene consists of at least three images: the 3D body model, a distant background, and a floor.

24. The method of claim 23, wherein background images are programmatically converted into a 3D geometry.

25. The method of claim 23, wherein a distant part of the background is placed independently of the floor section, with the distant image placed as a vertical plane, and the floor image oriented such that the top of the floor image is deeper than the bottom of the floor image.

26. (canceled)

27. The method of claim 23, wherein a depth value for each background image is set and stored m metadata tor a resource of the background image.

28. The method of claim 1, wherein within the screen, a scene is presented within a frame to keep it separate from other features, and the frame crops the contents so that when zoomed in or rotated significantly, edge portions of the scene are not visible.

29-33. (canceled)

34. The method of claim 1, wherein when a 3D textured geometry of the 3D virtual body model and the 3D garment dressed on the 3D virtual body-model are all present, generating a render with a rotated 3D virtual body model is implemented by applying a camera view rotation along the vertical axis during the rendering process.

35. The method of claim 1, wherein when 2D garment models are used for outfitting, generating a rotated version of 2D garment models involves first approximating the 3D geometry of the 2D garment model based on assumptions, performing a depth calculation and finally a corresponding 2D texture movement is applied to the image in order to emulate a 3D rotation.

36. The method of claim 1, wherein for a 2D torso-based garment model with a single 2D texture cut-out or silhouette, the 3D geometry model of the garment is approximated by applying the following simplifications: around the upper body, the garment closely follows the geometry of the underlying body shape; around the lower body, the garment approximates to an elliptic cylinder with varying axis lengths, centred at the origin of the body.

37. The method of claim 1, including the steps of: generating a smooth 3D mesh with faces from a point cloud of vertices given by depth approximations at each pixel, and generating a final normalised depth map of the garment for a required view.

38. The method of claim 37, wherein the depth map is used to calculate the extent to which a given point on the garment texture needs to move in the image in order to simulate an out-of-plane rotation about the vertical axis.

39. The method of claim 1, wherein an underlying head and neck base geometry of the user's 3D body shape model is used as an approximate 3D geometry and modeling a 3D rotation of the head sprite/hairstyle from a single 2D texture image using an approach of 2D texture morphing and morph field extrapolation is performed.

40-41. (canceled)

42. A computing device including a screen, a sensor system arid a processor, the computing device configured to generate a 3D virtual body model of a person combined with a 3D garment image, and to display the 3D virtual body model of the person combined with the 3D garment image on the screen, in which the processor:
(a) generates the 3D virtual body model;
(b) generates the 3D garment image for superimposing on the 3D virtual body model;
(c) superimposes the 3D garment, image on the 3D virtual body model;
(d) shows oil the screen the 3D garment image superimposed on the 3D virtual body model;
(e) detects a position change using the sensor system, and
(f) shows on the screen the 3D garment image superimposed on the 3D virtual body model, modified in response to the position change detected using the sensor system, wherein the modified 3D garment image superimposed on the 3D virtual body model shown on the screen is modified in perspective.

43. (canceled)

44. A system including a server and a computing device in communication with the server, the computing device including a screen, a sensor system and a processor, the server configured to generate a 3D virtual body model of a person combined with a 3D garment image, and to transmit to the computing device an image of the 3D virtual body model of the person combined with the 3D garment image, in which the server;
(a) generates the 3D virtual body model;
(b) generates the 3D garment image for superimposing on the 3D virtual body model;
(c) superimposes the 3D garment image on the 3D virtual body model;
(d) transmits the image of the superimposed the 3D garment image on the 3D virtual body model to the computing device;
and in which the computing device:
(e) shows on the screen the 3D garment image superimposed on the 3D virtual body model;
(f) detects a position change using the sensor system, and
(g) transmits to the server a request for a 3D garment image superimposed on the 3D virtual body model, modified in response to the position change detected using the sensor system;
and in which the server
(h) transmits an image of the superimposed the 3D garment image on the 3D virtual body model to the computing device, modified in response to the position change detected using the sensor system;
and in which the computing device:
(i) shows on the screen the 3D garment image superimposed on the 3D virtual body model, modified in response to the position change detected using the sensor system, wherein the modified 3D garment image superimposed on the 3D virtual body model shown on the screen is modified in perspective.

45-154. (canceled)
